(19) United States
(12) Patent Application Publication
(10) Pub. No.: US 2006/0277079 A1
(43) Pub. Date: Dec. 7, 2006

(54) Groupware travel itinerary creation

(76) Inventors: Geffrey Dale Gilligan, Palo Alto, CA (US); Eric Wood, Menlo Park, CA (US); Christian G. Bjoernsen, San Carlos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/408,845

(22) Filed: Apr. 20, 2006

Related U.S. Application Data
(60) Provisional application No. 60/673,808, filed on Apr. 22, 2005.

(51) Int. Cl. G01C 21/34

(52) U.S. Cl. 705/6

(57) ABSTRACT

Embodiments of the present invention provide methods and apparatuses facilitating groupware creation of a travel itinerary. The present invention enables querying of a backend application with an identifier of a groupware user. A past travel itinerary based on the identifier is retrieved to populate a template used to create a current travel itinerary. The template may be a graphical user interface representation of a workflow object. The user provides additional information regarding the trip. The information is submitted to the backend application, which determines options for each itinerary component (e.g. flight, car rental, and hotel) and a best match option for each component. The groupware client enables the user to select from the options to create a tentative travel itinerary. The groupware client may also enable the user to submit the tentative travel itinerary to another groupware user for approval, e.g. a supervisor.

### RELATED APPLICATIONS

The present application claims the benefit of priority under 35 U.S.C. § 119(e) and incorporates by reference in its entirety U.S. Provisional Application No. 60/673,808, filed on Apr. 22, 2005. The present application is also related to co-pending U.S. application Ser. No. 11/350,294, filed on Feb. 7, 2006.

### FIELD

Embodiments of the invention relate to business process workflow management, and more particularly to creation of a travel itinerary using groupware.

### BACKGROUND

A workflow generally refers to a flow of tasks associated with a business process. The tasks may be structured and/or ad hoc. A task may include one or more actions or activities (a series of actions). The business process typically involves people (sometimes referred to as participants of the workflow), organizational roles (e.g. manager, employee, etc), and documents, including records.

Some workflows are supported by computers that provide mechanisms for modeling, executing, and/or controlling the workflow. A user interacts with these mechanisms through a user interface (UI), typically a graphical user interface (GUI). A GUI is a graphical interface to a computing system that displays visual elements, e.g. icons and windows, on a display, e.g. a monitor. GUIs, as well as other user interfaces, may include non-visual interfaces, such as an audio interface, making the interface accessible to a wide variety of people.

Enterprises increasingly rely on computers to execute or help execute workflow tasks. Traditionally, to execute workflow tasks, multiple, unrelated desktop applications have been involved. For example, an employee may be assigned a task through an email application. The task may involve a creation of a travel itinerary. To decide on various options available for each travel component (e.g. flight, hotel, rental car) and get approval from a supervisor for a travel itinerary, the employee may access several different services (one for each component) and use several different applications (e.g. a browser, a calendar application, word processing application, and an email application). After the itinerary is approved, the employee may then use another application to submit the itinerary to the enterprise's travel or accounting department, often in a specific format.

Using multiple, independent applications can be not only time-consuming, but can also result in security/access issues. For example, one or more of the applications used to execute the task may be inadequately designed to provide the security/access control necessary to protect enterprise data involved in the workflow. Therefore, one or more applications that a workflow participant uses with regularity may be less secure and/or less capable of dealing with enterprise business process tasks. Additionally, manual transfer of the data from one application (or device) to another to complete the task also exposes the integrity of the enterprise data to unnecessary risks. Furthermore, using multiple, independent applications makes it difficult for the enterprise to use the computing system to assist workflow participants in complying with procedures and policies set forth by the enterprise to complete a workflow.

### SUMMARY

The invention provides a method for facilitating groupware creation of a travel itinerary including: receiving, via a groupware client, a request to create a first travel itinerary for a trip of a user having a user identifier; in response to the request, querying a database for a second travel itinerary stored in association with the identifier; providing, via the groupware client, the second travel itinerary as elements of an interface of the groupware client; receiving, via the interface of the groupware client, information relating to the trip; generating travel itinerary options based on the information; identifying from among the travel itinerary options a best match based on a travel policy of an organization authorizing the trip; and transmitting to the groupware client the travel itinerary options with the best match pre-selected.

Receiving the information may include receiving the information from a groupware server.

The method may further include receiving from the groupware client a selection from among the travel itinerary options; generating a workflow item for an individual authorized by the organization to review the selection; and notifying the individual of the workflow item via a second groupware client used by the individual.

The second groupware client may include an email client and notifying the individual comprises transmitting an object to the email client, the object including one or more tools selectable by the individual to approve or deny the selection.

The method may further include determining the individual authorized by the organization to review the selection based on at least one of: an organizational role of the user, a purpose of the trip, and a cost associated with the selection.

The method may further include automatically generating another workflow item for another individual in the organization when the selection is associated with a cost exceeding a budgeted value.

The invention also provides a machine readable medium having instructions which when executed by a processor cause the processor to perform operations including providing, in a groupware client, a tool to create a travel itinerary; in response to selection of the tool, providing an interface in the groupware client to receive trip information; transmitting the trip information to a backend application; receiving from the backend application travel itinerary options, at least one of the options identified as a best match option; presenting the options with the best match option pre-selected; receiving a selection from among the itinerary options; making a reservation based on the selection; and automatically creating in the groupware client a calendar entry based on the selection.

The operations may further include, in response to the selection, creating a workflow item; and transmitting a notification of the workflow item to a second groupware client.

The notification may include graphical user interface tools enabling approval or rejection of the selection.

The operations may further include, in response to an approval of the selection, changing the calendar entry to indicate the approval.

The operations may further include, in response to an approval of the selection, automatically generating an expense report based on the selection.

The operations may further include: receiving a selection of the calendar entry; and in response to the selection, enabling alteration of the travel itinerary.

The operations may further include: in response to a request to alter the travel itinerary, retrieving from the backend application updated travel itinerary options.

The invention further provides a device for facilitating groupware creation of a travel itinerary including: a storage system interface connected to a storage system storing a travel policy of an organization and a past travel itinerary of a user representing the organization; a groupware interface connected to a groupware client, the groupware interface receiving trip information from the user via the groupware client; and a backend application connected to the groupware interface and the storage system interface, the backend application providing travel itinerary options based on the past travel itinerary and the trip information, the backend application further identifying a best match from among the travel itinerary options based on the travel policy of the organization.

The groupware interface may be further connected to a groupware server and the backend application may include a service creating, in response to receiving from the user a travel itinerary based on the options provided, a workflow item for another user, the service further notifying the other user of the workflow item via the groupware server.

The backend application may include a service which generates an expense report in response to receiving from the user a travel itinerary.

The travel policy of the organization may identify at least one of: a travel budget maximum, a travel authorizing individual in the organization, a preferred airline, a preferred hotel chain, and a preferred vehicle rental company.

The invention further includes a system for collaborative determination of a travel itinerary including: a business process server including a groupware interface and a backend application; a first groupware client connected to the server via the groupware interface, the first groupware client receiving from the backend application travel itinerary options based on an organizational travel policy, the first groupware client further enabling a first user to select from the travel itinerary options to create a travel itinerary; and a second groupware client connected to the groupware interface of the server, the second groupware client receiving from the server the travel itinerary and enabling a second user to approve or reject the travel itinerary.

The second groupware client may further receive from the server budget information along with the travel itinerary.

The system may further include: a groupware server connected to the business process server, the first client, and the second client, the groupware server creating in the first client a calendar entry having a tentative status in response to creation of the travel itinerary and changing the tentative status to an approved status in response to receiving from the second client an indication of approval of the itinerary by the second user.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1a is a block diagram of a network scheme implementing one embodiment of this invention;

FIG. 1b is a block diagram of one particular aspect of components of FIG. 1a;

FIG. 2 is a flow diagram of groupware creation of a travel itinerary using the components shown in FIG. 1a;

FIGS. 3a-3b are a flow diagram of operations in accordance with FIG. 2;

FIGS. 4a-4h are representations of a user interface (UI) in accordance with FIGS. 3a-3b;

FIG. 5 is a flow diagram of additional operations in accordance with FIG. 2;

FIGS. 6a-6b are representations of a user interface in accordance with FIG. 5;

FIG. 7 is a flow diagram of further operations in accordance with FIG. 2;

FIGS. 8a-8b are representations of a user interface in accordance with FIG. 7;

FIG. 9 is a flow diagram of further operations in accordance with FIG. 2;

FIGS. 10a-10b are representations of a user interface in accordance with FIG. 9;

FIG. 11 is a flow diagram of further operations in accordance with FIG. 2;

FIGS. 12a-12d are representations of a user interface in accordance with FIG. 11;

FIG. 13 is a flow diagram of further operations in accordance with FIG. 2;

FIGS. 14a-14b are representations of a UI in accordance with FIG. 13; and

FIG. 15 is a block diagram of an illustrative business process.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein.

As used herein, travel is movement of one or more persons (e.g. a participant of a workflow) on a trip (or journey). An itinerary is a route or proposed route of a trip. Therefore, a travel itinerary is a route or proposed route moving a person on a trip. Trip information is information related to the trip, including but not limited to the travel itinerary, a budget for the trip, a purpose for the trip, objectives for the trip, contact information, and the like.

In the example described herein, the trip is a business trip in which one or more other workflow participants (e.g. a manager and/or another individual with expense authorization authority) reviews the travel itinerary and approves, rejects, and/or discusses the travel itinerary (and perhaps other trip information) with the traveling individual.

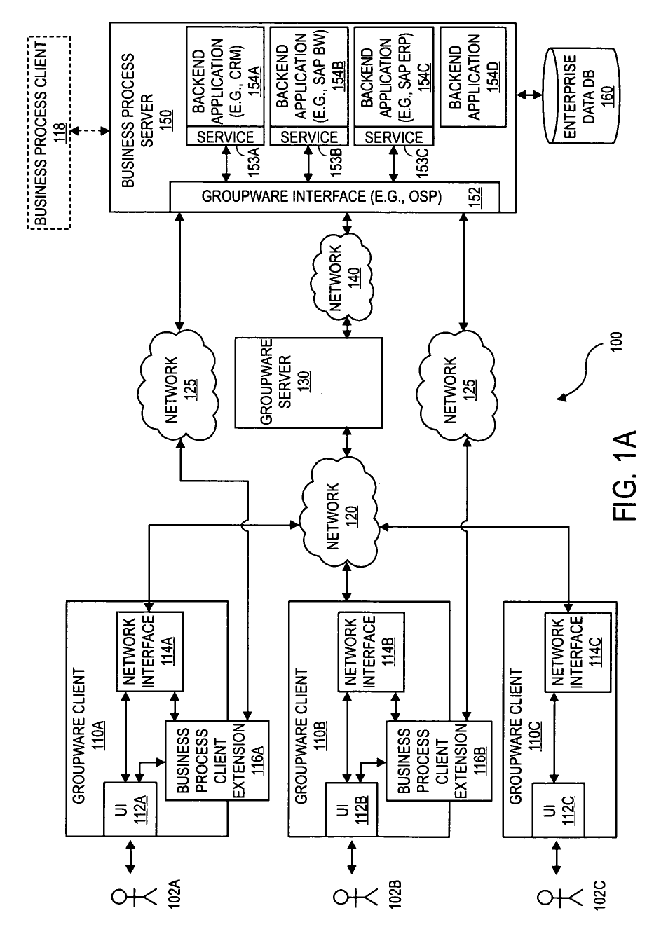

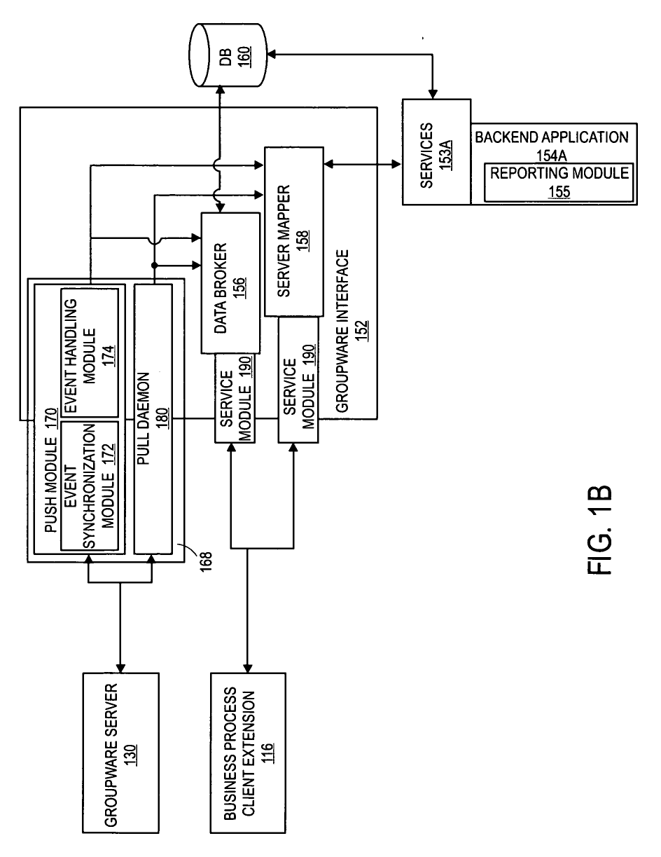

FIG. 1a illustrates a network scheme 100 in accordance with one embodiment of this invention. The network scheme 100 includes groupware clients (e.g., 110A, 110B, and 110C), one or more networks (e.g. the networks 120, 125, and 140), a groupware server 130, a business process server 150, an enterprise data database 160, and an optional business process client 118.

A “backend” (or “back-end”) is the component of a computing entity which processes input from a front end. In FIG. 1a, the backend includes the groupware server 130, the business process server 150, and the enterprise data database 160. The database 160, as used herein, represents a storage system which may include one or more one or more conventional database as well as one or more repositories, e.g. repositories storing service objects, metadata, and/or other data and/or objects describing and/or using data stored in a conventional database. In certain implementations, the objects (e.g. business objects) are modeled objects, i.e. the objects are created via modeling, thereby allowing an individual without programming experience to create the object. A “frontend” (or “front end”) is the component of a computing entity which directly interfaces with a user. A graphical user interface (GUI) is an example of a frontend. In FIG. 1a, each groupware client includes a frontend. In some instances, the entire client is deemed the frontend.

Each groupware client includes a user interface (e.g. 112A, 112B, or 112C) and a network interface (e.g. 114A, 114B, and 114C). Groupware clients 110A and 110B each also include a business process client extension (e.g. 116A and 116B).

The business process server 150 includes a groupware interface 152, services 153A, 153B, and 153C, and backend applications 154A, 154B, 154C, and 154D. Backend applications 154A, 154B, and 154C are accessible to the groupware clients and/or groupware server via the groupware interface 152 and a respective service (e.g. 153A). The backend application 154D is not directly accessible to the groupware clients and/or groupware server via the groupware interface 152, but is used by one or more of the other backend applications. For example, in FIG. 1a, the backend application 154D allows the other backend applications (e.g. 154A) to access the database 160. The database 160 stores enterprise data, including confidential information, e.g. personnel records, past travel itineraries, a travel policy of an organization (e.g. the enterprise or a customer). Accordingly, the backend includes a storage system interface connected to a storage system (e.g. the database 160).

A backend application (e.g. 154A, 154B, 154C, or 154D) includes, for example, a customer relationship management (CRM) application, a data warehouse solution (e.g. the SAP® Business Information Warehouse (BW)), a management information system (e.g. the SAP® Enterprise Resource Planning System (ERP)), or other business process applications which provides services to a client (e.g. the business process client 118 or the groupware client 110A via the groupware interface 152). One or more of the backend applications is connected to the groupware interface 152 and a storage system interface for communicating with a storage system (e.g. the database 160). One or more of the backend applications provides travel itinerary options based on a past travel itinerary and trip information. One or more of the backend applications also identifies a best match from among the travel itinerary options based on a travel policy of the organization.

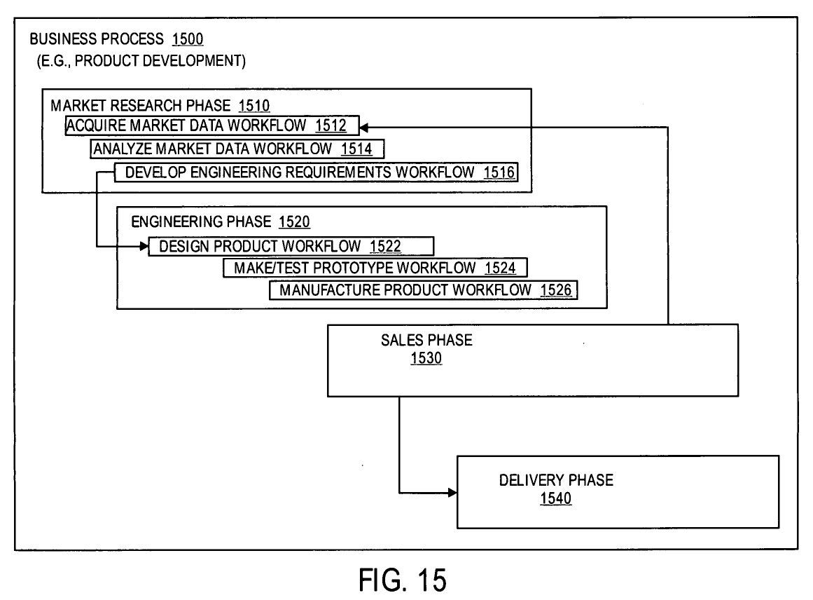

As used herein, a “business process” refers to a process used to perform work within an enterprise. FIG. 15 illustrates an example of a business process. In FIG. 15, the business process 1500 is the development of a product. The business process 1500 includes multiple phases, including a market research phase 1510, an engineering phase 1520, a sales phase 1530, and a delivery phase 1540.

Each phase includes one or more workflows. For example, the market research phase 1510 includes three workflows: a workflow 1512 to acquire market data, a workflow 1514 to analyze the market data, and a workflow 1516 to development engineering requirements based on the analysis. A workflow may include context in terms of organizational roles of participants, as well as documents, forms, or other data.

Each workflow includes one ore more structured and/or ad hoc tasks. Each task is executed and/or performed to progress towards the end-goal of the business process. For example, the workflow 1515 may involve the tasks of surveying end-users of the product, contacting a market research firm for data, and gathering data on competitor products.

Each task involves one or more actions. For example, contacting the market research firm may involve making a phone call. Surveying end-users of the product may involve gathering end-user contact information, developing a survey, and executing the survey.

Accordingly, each workflow involves one or more individuals (e.g. the users 102A-102C in FIG. 1a). Each individual involved in a workflow is responsible for ensuring the workflow is completed and/or is responsible for performing the workflow task(s). For example, one individual (e.g. 102A) may be involved in making a phone call to contact a market research firm. A team of workflow participants may be involved in gathering data on competitor products, searching the web for product literature, and ordering products, while another participant, e.g. a supervisor of the team, is responsible for ensuring the tasks are complete. An individual may become involved in a workflow only after certain conditions arise, e.g. when a cost of completing a task exceeds a budgeted amount.

In some business processes, the phases are non-sequential. For example, in some product development business processes, the sales phase 1530 begins before the engineering phase 1520 is complete.

Additionally, in some business processes, the phases are not independent. Events in one phase may affect activity in another phase. For example, in one business process, although the engineering phase 1520 has begun, new market data (perhaps obtained during the sale phase 1530) changes the requirements of the product, thereby affecting an engineering phase workflow, e.g. a workflow 1522 to design the product. Accordingly, in certain implementations, one or more of the workflows are dynamic, e.g. changing based on events occurring during the workflow or in another workflow, or newly modeled objects added to the workflow.

Completion of a workflow often includes collaboration between many individuals. To facilitate completion of the workflow, the present invention provides groupware. As used herein, “groupware” refers to any of a type of collaborative software, for example, email software, whiteboard software, spreadsheet software, etc. Groupware is typically associated with client(s) and server(s). A groupware event is an event which is organized using groupware. A groupware event is typically involves multiple workflow participants, e.g. by being collaborative (e.g. a meeting) or being a delegated task.

In FIG. 1a, users (e.g. 102A, 102B, and 102C) collaboratively participate in a workflow using groupware clients and the groupware server. Each groupware client (e.g. 110A) is connected to the groupware server 130 via a network 120.

A groupware server (e.g. 130) is hardware and/or software that provides centralized services accessible to one or more groupware clients (e.g. 110A-110C). For example, a groupware server such as the Microsoft® Exchange Server provides centralized email delivery and filtering services accessible to one or more groupware clients, e.g. Microsoft® Outlook clients. Accordingly, the groupware server includes one or more network interfaces (not shown) to provide the services to the clients.

Each groupware client includes programs, routine, etc., that allows interaction with the groupware server 130. The programs, routines, etc. interact with the groupware server via a network interface (e.g. the network interface 114A in the client 110A).

Specific instances of client-to-server interaction may be initiated by a user (e.g. the user 102A). For example, in one use, the user 102A, using the UI 112A, composes and submits an email (or other groupware object described herein) destined for another user (e.g. 102B). The groupware client 110A transmits the email (or other groupware object) to the groupware server 130 via the network interface 114A. The groupware server 130 processes the email and transmits it to the groupware client 110B, via the network interface 114B. The groupware client 110B is associated with the user 102B, e.g. in response to the user 102B logging into the groupware client 110B.

In FIG. 1a, the groupware server 130 (e.g. the Microsoft® Exchange Server) is also connected to the business process server 150 (e.g. an SAP® server), e.g. via a network 140. The business process server 150 is hardware and/or software and includes components used to manage and/or assist in the execution of a business process. For example, in one implementation, a business process server component, such as the backend CRM application 154A (and its respective service 153A), is used to track current or potential customers acquired during the sales phase 1530 of the business process 1500. In one implementation, a backend accounting application is used to generate and track invoices to customers.

Accordingly, in use, a groupware client 110A (e.g. a Microsoft® Outlook client) transmits information (e.g. a charge) to the groupware server 130 (e.g. a Microsoft® Exchange Server). The information is transmitted using a groupware object, e.g. a generic email object or a groupware object specifically designed to interact with the business process server. The groupware server 130 then transmits at least part of the information, in some instances after further processing, to the business process server 150 (e.g. an SAP® server).

Business process server extensions (e.g. 116A and 116B) enable the groupware client (e.g. 110A) to communicate with the business process server 150, with or without first communicating with the groupware server. The extensions provided to the groupware client enable integration of business process tasks into the environment of the groupware client. Accordingly, a workflow participant (e.g. user 102A) can interact, e.g., create, process, track, set preferences, etc., with a workflow through the user interface of the groupware client. The user interface (e.g. 112A) of a groupware client is likely to be familiar to the workflow participant, and allow the integration of tools of the groupware client (e.g., spellchecking, translations, etc.) into the performance of the workflow task.

With extensions, a workflow participant accesses and interacts with workflows that are otherwise accessible only via an independent client, e.g. the business process client 118. The integration of access to business process tasks enables the workflow participant to act on contextual information (e.g., reports, documents, hints, data, etc.) locally from within a groupware application. The participant is able to generate a workflow, receive status or other information regarding one or more tasks of a workflow, and/or process or execute a task of a workflow.

The groupware client accesses data objects, forms, functions, services, data structures, and/or processes that exist or are managed in the business process server 150 and the enterprise data database 160. Status information, for example, is provided to the groupware client to provide updated information for the business process within the groupware client. Status information is also accessible when the workflow participant selects an item/icon or executes an action within the groupware client.

In contrast to the integrated use of groupware with a workflow as described herein, current email notifications or other traditional functions of groupware focus only on a single task or action with respect to the workflow. With the integration of groupware functionality and enterprise access, the business process information associated with a workflow presented in the groupware application is persisted with the integrated groupware client. Persisting the information refers to making the information available to the workflow participant either continuously, or upon request, and from within the context of the groupware client. Persisting the information may include storing the information locally to the groupware client, or within a storage location within a groupware server, in addition to storing the information within the enterprise backend.

FIG. 1b illustrates components used in interactions between the groupware and the business process server. In FIG. 1b, the groupware interface includes a groupware server interface 168, a data broker 156, a service mapper 158, and service modules 190. The groupware interface connected to the groupware client (e.g. via the groupware server interface and/or the service module 190). The groupware interface receives trip information from a user (e.g. 102A) via the groupware client (e.g. 110A) connected to the interface.

The groupware server interface 168 includes a push module 170 and/or a pull daemon 180. The push module 170 includes an event synchronization module 172 and an event handling module 174. The push module enables the groupware interface 152 to push information to the groupware server 130 based on an occurrence of an event. The pull daemon 180 enables the groupware interface 152 to pull information from the groupware server 130. In one implementation, the groupware server interface 168 is a Java® interface. The groupware server interface 168 is connected to the data broker 156 and the service mapper 158.

The data broker 156 is connected to the database 160 and provides access to data stored in the database 160. The service mapper 158 maps services available in the business process server, e.g. the service 153A. The service 153A provides access to, for example, metadata, Enterprise Services Architecture (ESA) services from SAP®, functions, and routines of the backend application 154A. The backend application 154A (or another backend application in the business process server 150) may include a reporting module 155 to generate a report based on information processed by the backend application and stored in the database 160. Accordingly, a backend application may include a service which generates an expense report in response to receiving a travel itinerary from a user (e.g. a tentative itinerary from the user 102A or an approved itinerary from the user 102B).

The data broker 156 and the service mapper 158 in the business process server are also accessible via the service module 190.

A groupware client uses the business process client extension 116 to access the groupware interface. In one instance, the groupware client uses the business process client extension 116 to communicate to the groupware server, and then access the groupware interface 152 via the groupware server interface 168. In another instance, the groupware client uses the business process client extension 116 to communicate to the service module 190 to access the groupware interface 152, thereby bypassing the groupware server 130. In one implementation, the service module 190 is a web service module and the business process client extension 116 communicates with the service module 190 using a protocol, e.g. HyperText Transfer Protocol (HTTP).

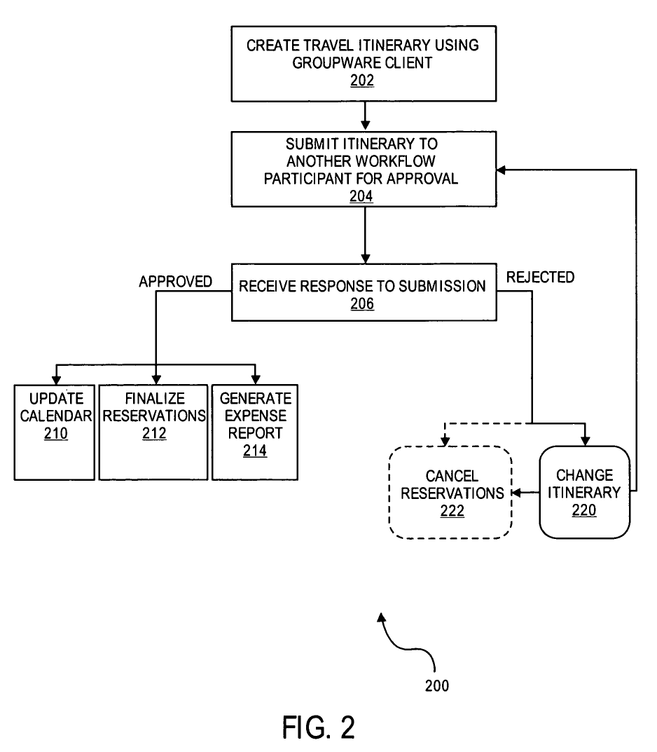

Using one or more of the components shown in FIGS. 1a and 1b described above, groupware creation of a travel itinerary is achieved. FIG. 2 is a flow diagram 200 of a travel itinerary creation using the components discussed above.

At 202, a travel itinerary for a trip is created using a groupware client. The travel itinerary is created by creating a groupware workflow object. A workflow object is any object which contains information associated with a workflow. The workflow object typically represents a task in the workflow, e.g. by identifying an action to be completed in order to further process of the workflow. A groupware workflow object is any workflow object which is transmitted to and from groupware components (e.g. the groupware client and the groupware server).

A groupware workflow object may be or include, for example, an email object, a calendar object, a task list object, a contacts object. The email object identifies individuals associated with a workflow (e.g. in the To, From, Cc, or Bcc field) and may describe actions to be taken or record workflow tasks which are completed.

In the example described here, the workflow object is a travel request object. A travel request object is a groupware workflow object having specific properties relevant to requesting travel from the enterprise, e.g. properties related to creating a travel itinerary that will be approved by other individuals in the organization (e.g. other workflow participants).

Accordingly, in one implementation, at 202, a groupware user (e.g. 102A) opens a travel request workflow object in a groupware client (e.g. 110A). The groupware client queries a backend application (e.g. 154D) with an identifier of the user, e.g. an employee identification number. In use, the identifier is determined when the user (e.g. 102A) logs into the groupware client (e.g. 110A) and is automatically associated with the workflow object when the user creates the travel request workflow object using the groupware client (e.g. 110A).

In response to the query, a backend application searches for content of prior travel itineraries (also referred to as past travel itineraries) associated with the user identifier, and therefore, associated with the user. The backend application (e.g. 154D) communicates the content to the groupware client through the groupware interface 152, e.g. via the groupware server or through a service module 190, to the business process client extension 116 associated with the client (e.g. the business process client extension 116A associated with the groupware client 110A). The content is presented to the user, e.g. as elements of an interface of the groupware client. For example, in one implementation, the content populates a template representing the travel request object.

The content presented to the user 102A aids the user 102A in making a new travel itinerary based on prior itineraries. In use, the user makes additional selections (e.g. using tools accessible via the user interface 112A) and/or alters information shown on the template.

The user selects a tool in the user interface to submit the template representing the workflow object to the backend. In response to the selection, the groupware client submits the information to the backend application, e.g. by transmitting the workflow object to the backend application, through the groupware server or through the service module 190. Based on the submitted information, the backend application determines itinerary components (e.g. flights, hotels, rental cars) that match the submitted information.

In certain configurations, the backend application determines the components by communicating with an external server, e.g. that of an airline, hotel, or car rental company. In certain configurations, the backend application determines the components based on preferences stored in a database (e.g. 160). The preferences are determined by at least one of: a travel policy of the enterprise, the individual traveler (e.g. the user 102A), and a supervisor of the individual traveler.

The backend application sends the results of the determination to the groupware client identifying a “best match” option for each itinerary component. A best match option is an option which most closely correlates to the trip information, e.g. a desired travel date and time. In certain implementations, the best match option also determined based on a travel policy of an organization (also referred to as an organizational travel policy) authorizing the trip (e.g. the enterprise employing the traveling user or the organization with whom the user is traveling to meet) and/or the user's stored preferences. The travel policy identifies at least one of: a travel budget maximum, a travel authorizing individual in the organization, a preferred airline, a preferred hotel chain, and a preferred vehicle rental company.

The groupware client 110A presents the results to the user with the best match itinerary components pre-selected. The groupware client 110A also enables the user to alter the pre-selected components, e.g. to select a flight other than the pre-selected best match flight.

At 204, the itinerary is submitted to another workflow participant for approval. In some implementations, if the user 102A will not submit the itinerary to another workflow participant for approval (e.g. if the user has a certain role in the organization and/or if the company reviews travel itineraries only via expense reports). In one implementation, when the itinerary is submitted, the groupware server and/or client automatically creates a calendar entry in the groupware client based on the submit itinerary, e.g. based on a selected flight or selected travel date.

In one implementation, when the itinerary is submitted, a workflow item is created for an individual authorized by the organization to review the selection, e.g. a supervising user 102B. The groupware client and/or the groupware server and/or the business process server automatically determines the individual authorized by the organization to review the selection based on at least one of: an organizational role of the traveling user, a purpose of the trip, and a cost associated with one or more selected itinerary options. In one implementation, when the cost of a selected option exceeds a budgeted value, the business process server changes or adds an individual to authorize the trip in accordance with a travel policy. Accordingly, in one implementation, when a selection is associated with a cost exceeding a budgeted value, the business process server (and/or the groupware server and/or the groupware client) automatically generates another workflow item for another individual in the organization. In another implementation, the user 102B inputs the individual who will be approving of the travel itinerary (e.g. into a field of the travel request object).

The user 102B receives a notification of the submitted itinerary. In use, the groupware server and/or business process server notifies the supervising user 102B of the workflow item via a groupware client 110B used by the supervising user 102B. For example, in one configuration, the groupware client 110B includes an email client. The groupware server and/or business process server transmits a workflow object containing information regarding the itinerary to an email inbox of the groupware client 110B associated with the user 102B. Typically, the workflow object will be represented by a GUI which includes one or more tools selectable by the user 102B to approve or deny the itinerary selections.

The user 102B responds to the submitted itinerary, e.g. selecting one of the tools available in the GUI representing the workflow object. The groupware client 110B transmits the response (e.g. the acceptance or rejection) to the backend. The other workflow participant's response to the submission is also transmitted to the traveling user 102A.

At 206, the response to the submission is received (e.g. by the groupware server to forward to the groupware client 110A and/or by the groupware client 110A). The user 102A views the response. If the itinerary was rejected, the groupware client 110A enables the user 102A to change the itinerary. At 220, the user changes the itinerary and submits the changed itinerary for approval at 204.

In certain configurations, the backend (e.g. a backend application 154D) makes temporary reservations prior to the itinerary being approved by the other workflow participant (e.g. 102B). In those configurations, if the itinerary is rejected, the backend application cancels the reservations. Typically, the backend application will not cancel the reservations until after the traveling user 102A receives the response and selects to cancel the travel request or to change the itinerary because the workflow participant who rejected the plan (e.g. 102B) may not have rejected all of the itinerary, but rather a certain selected option.

In one configuration, if the itinerary was approved, the groupware server and/or client automatically updates at 210 a calendar of the user 102A to reflect the travel plans. At 212, the groupware server and/or client also communicates with the backend application to finalize the reservation, e.g. if the reservation was a temporary 24 hour hold.

At 214, the groupware client and/or the backend application generates an expense report based on the approved travel itinerary. In one implementation, the expense report is automatically generated in response to an approval of the selection. The expense report is based on one or more of the selections in the travel itinerary. The expense report is transmitted to the traveling user 102A, the supervising user 102B, any other workflow participants who may be associated with the trip, and/or a backend application (e.g. an accounting application).

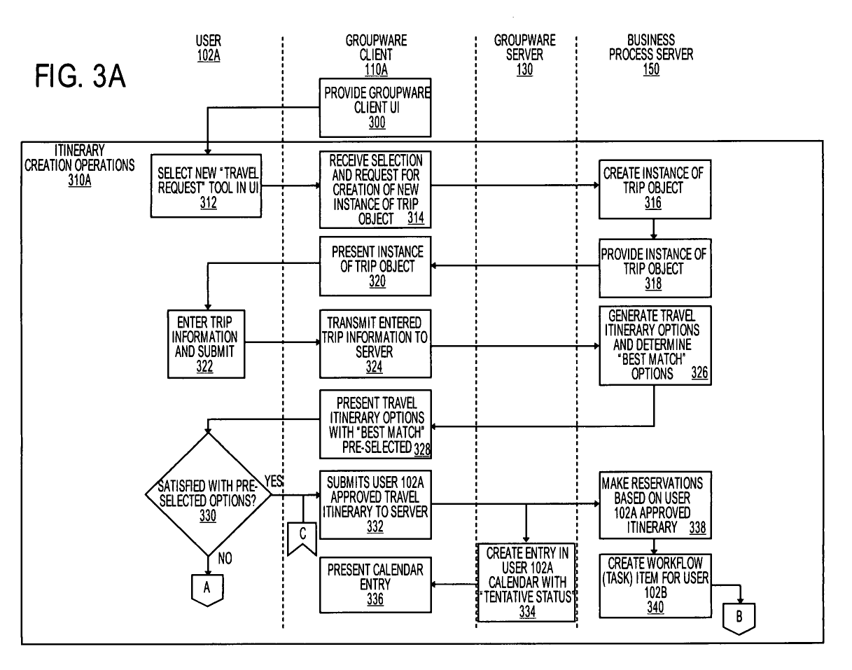

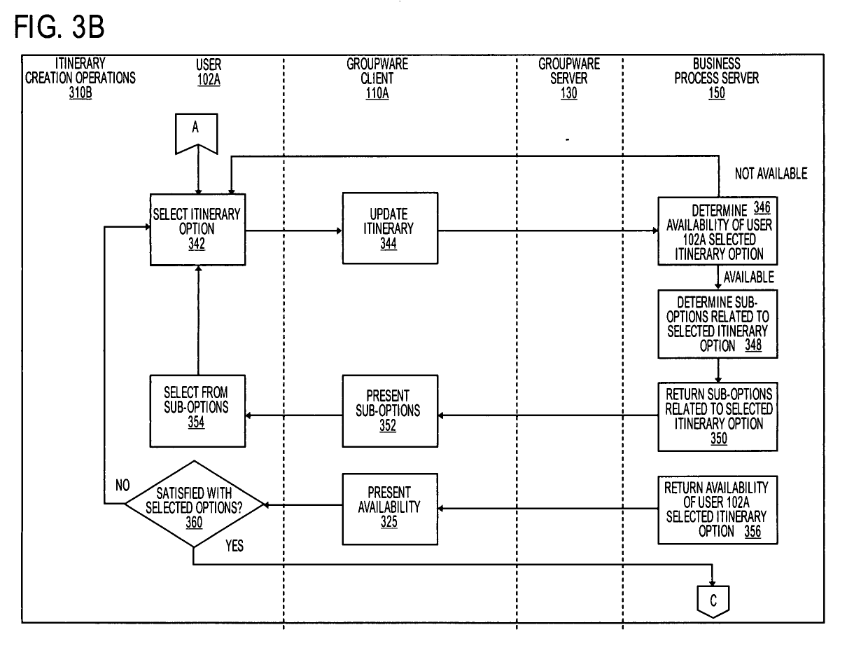

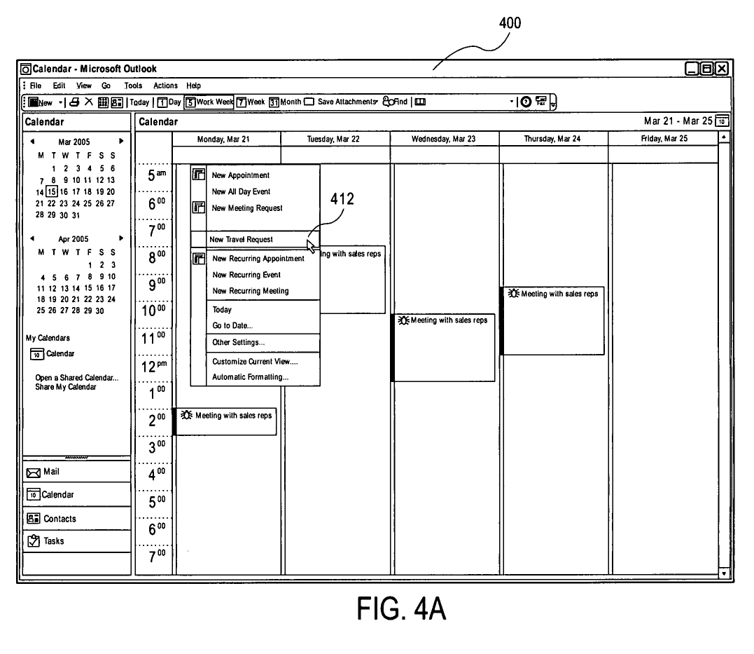

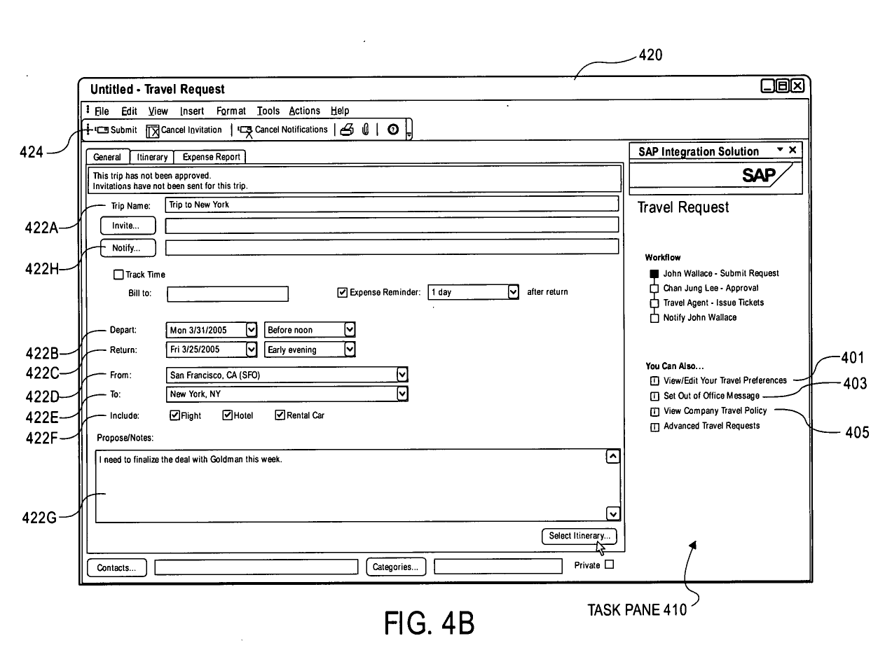

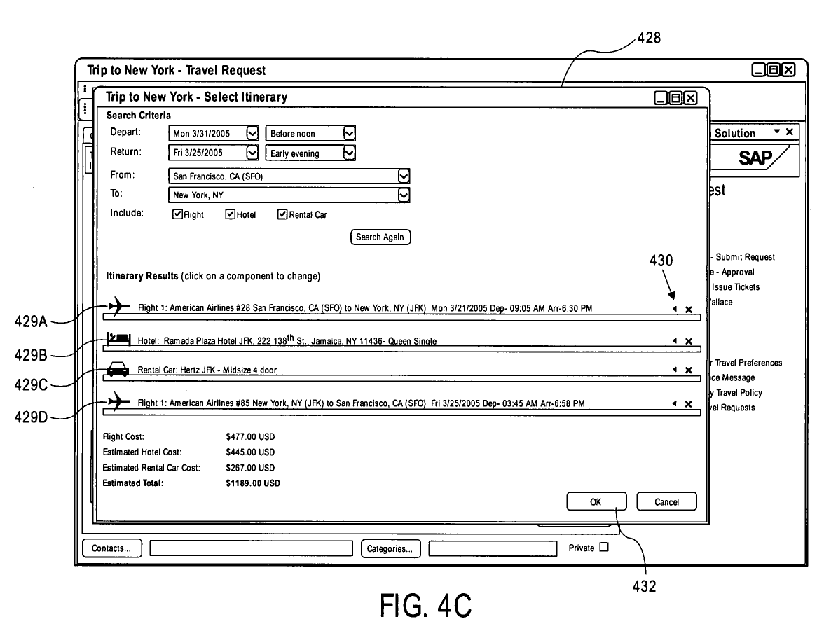

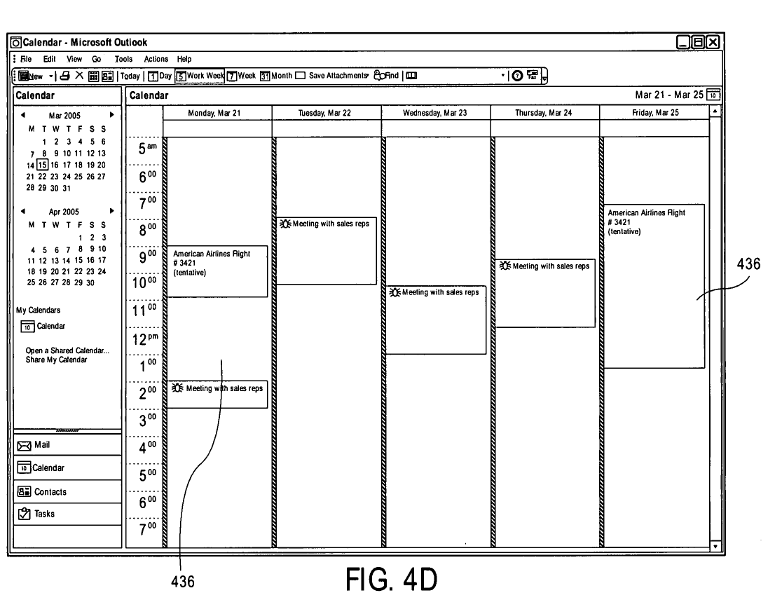

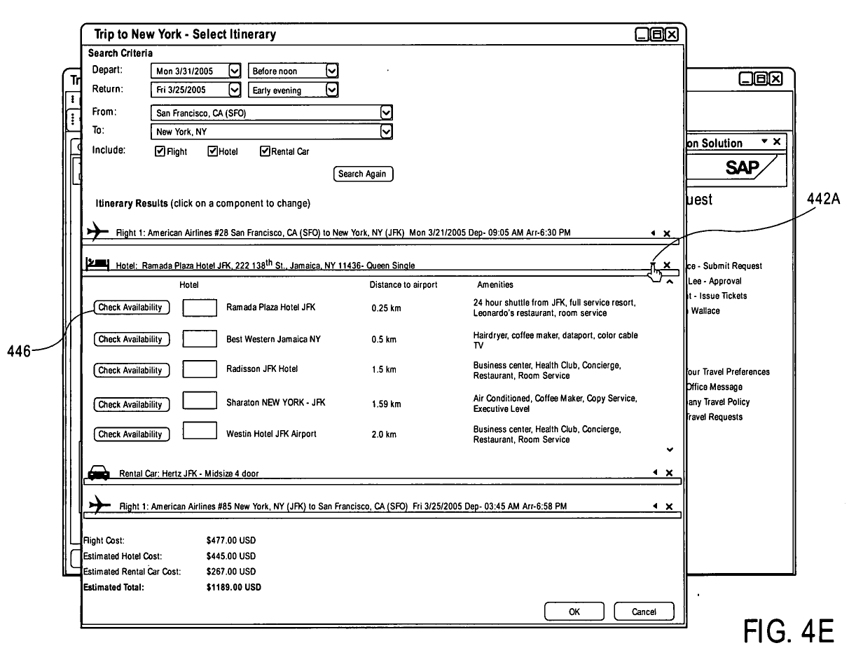

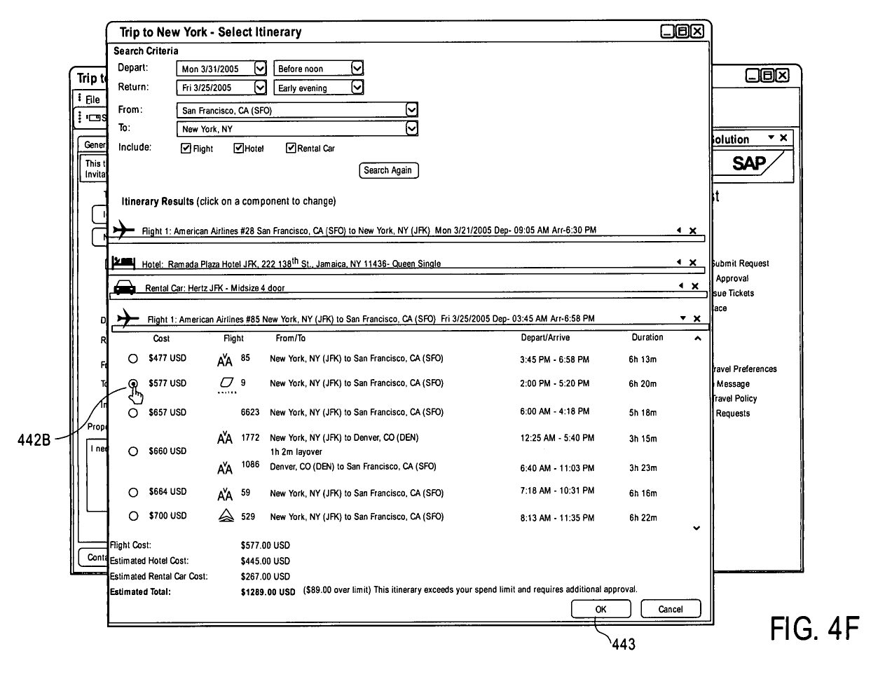

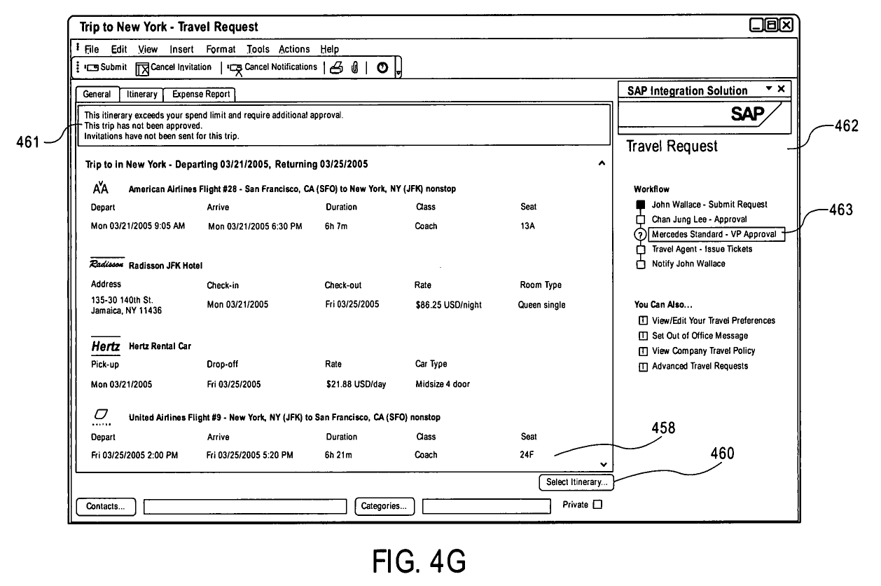

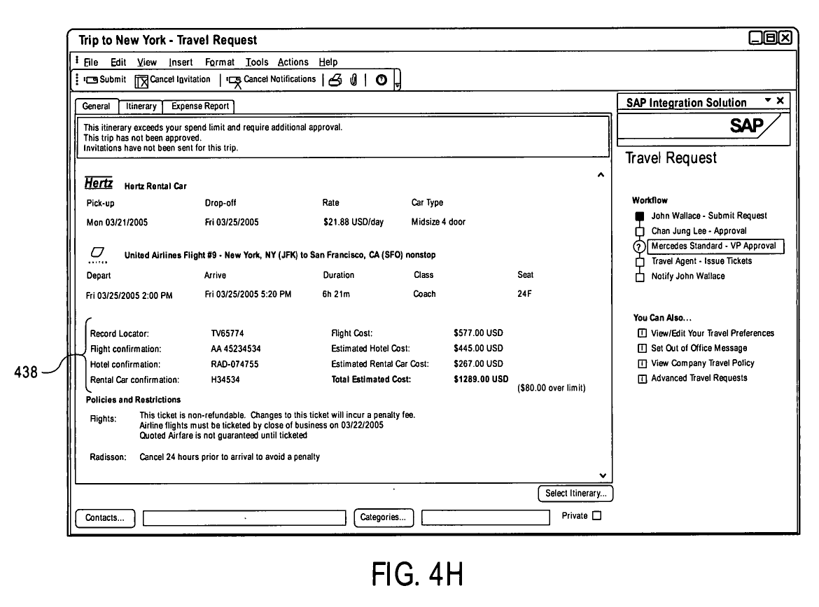

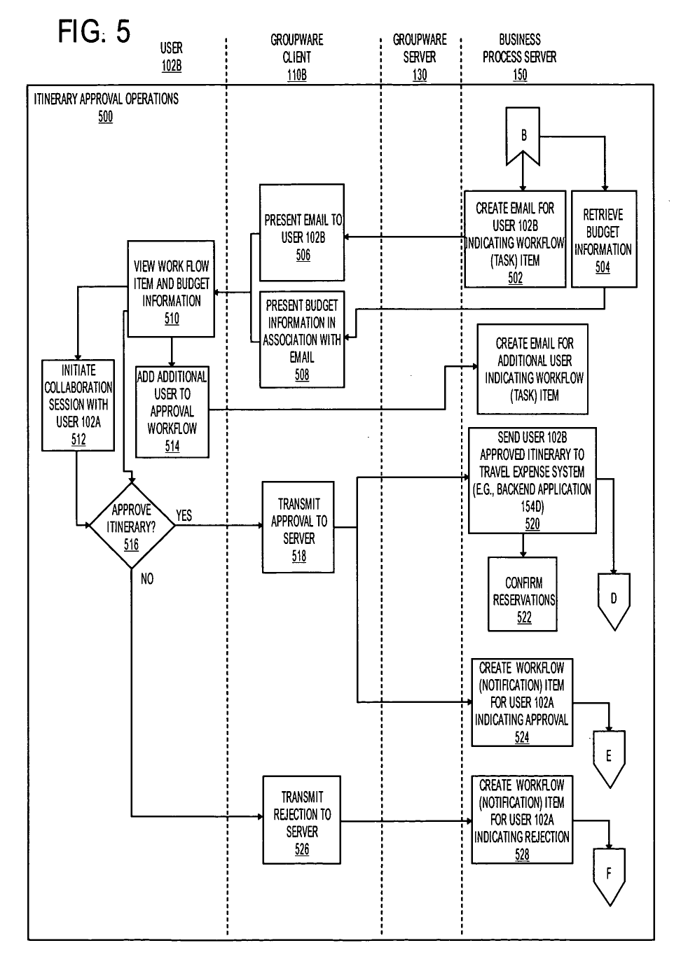

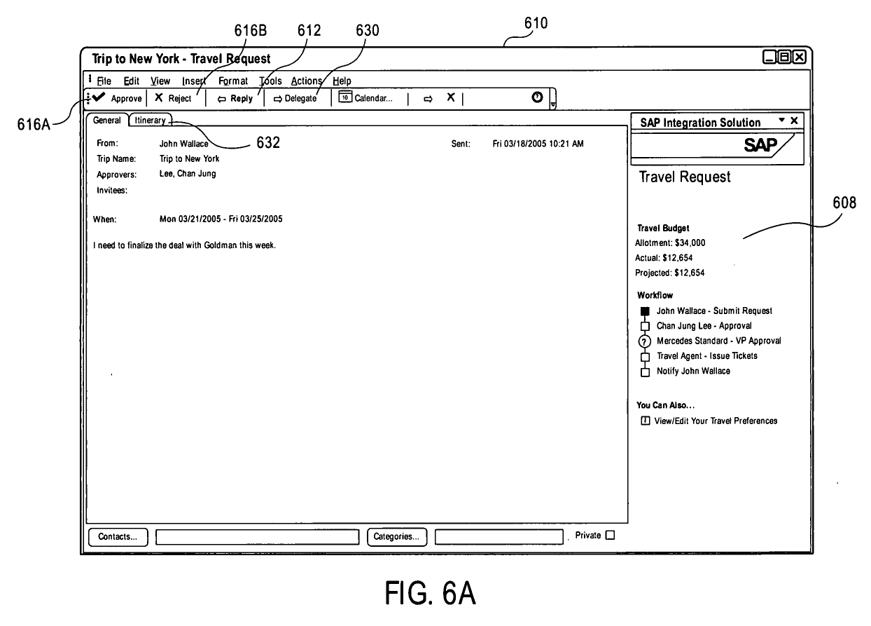

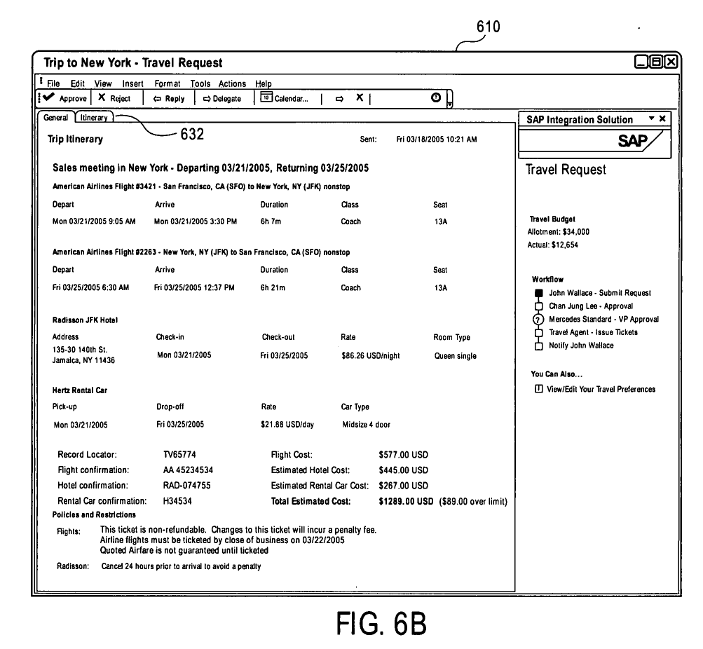

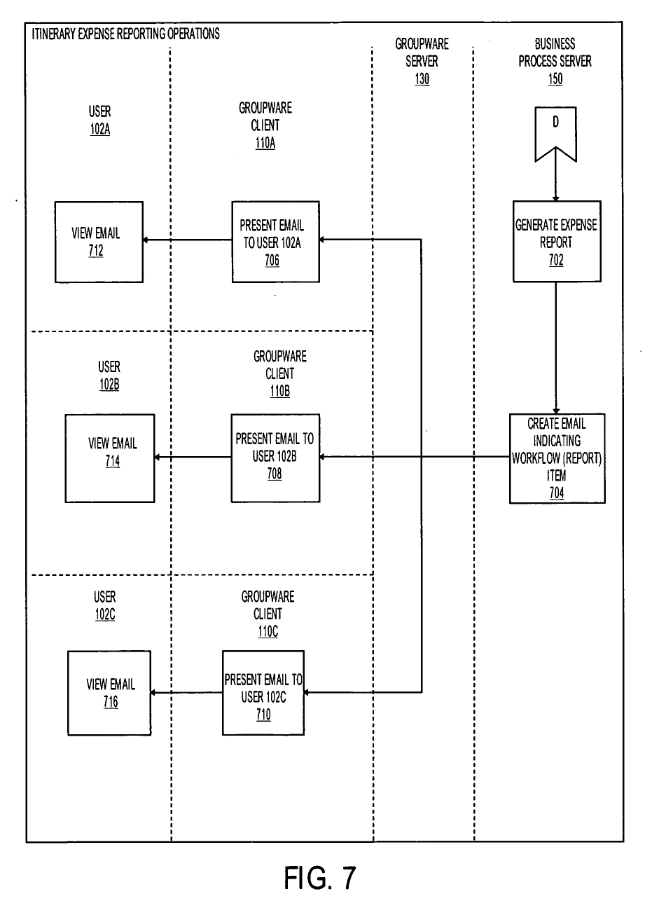

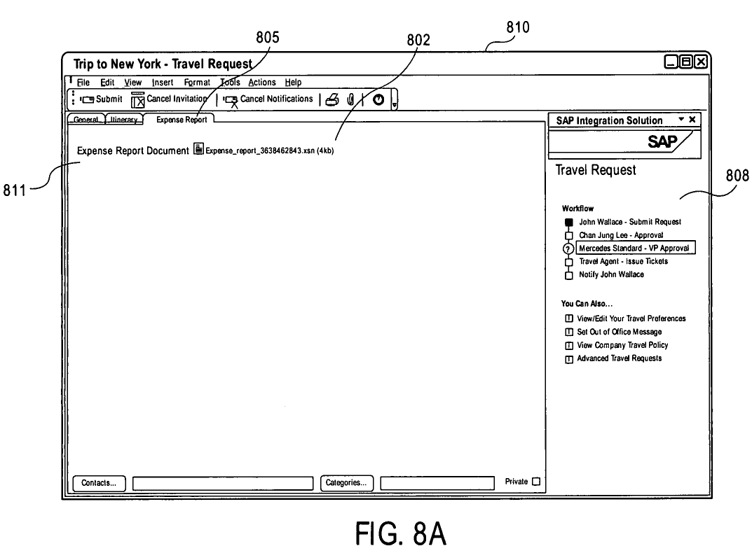

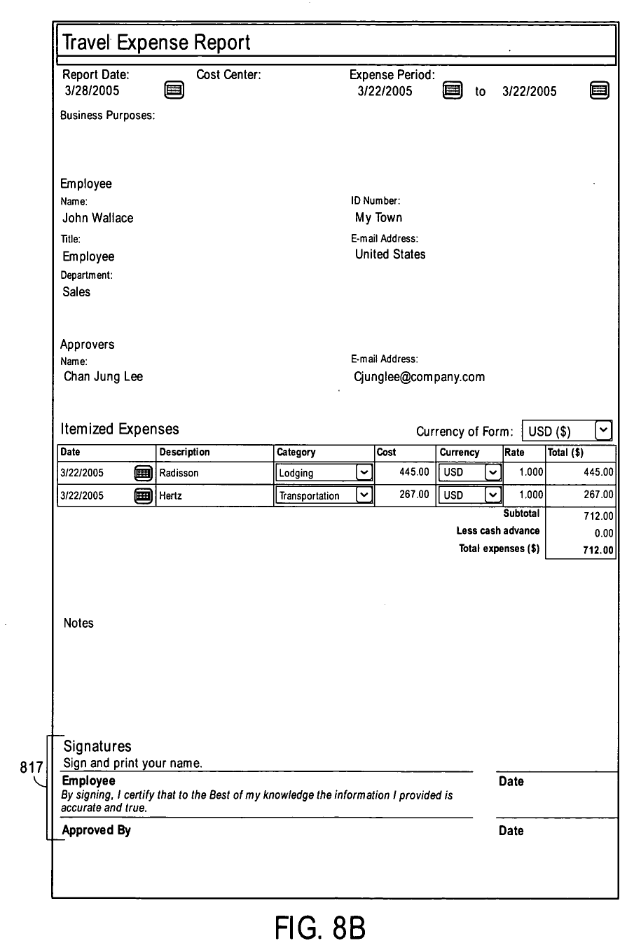

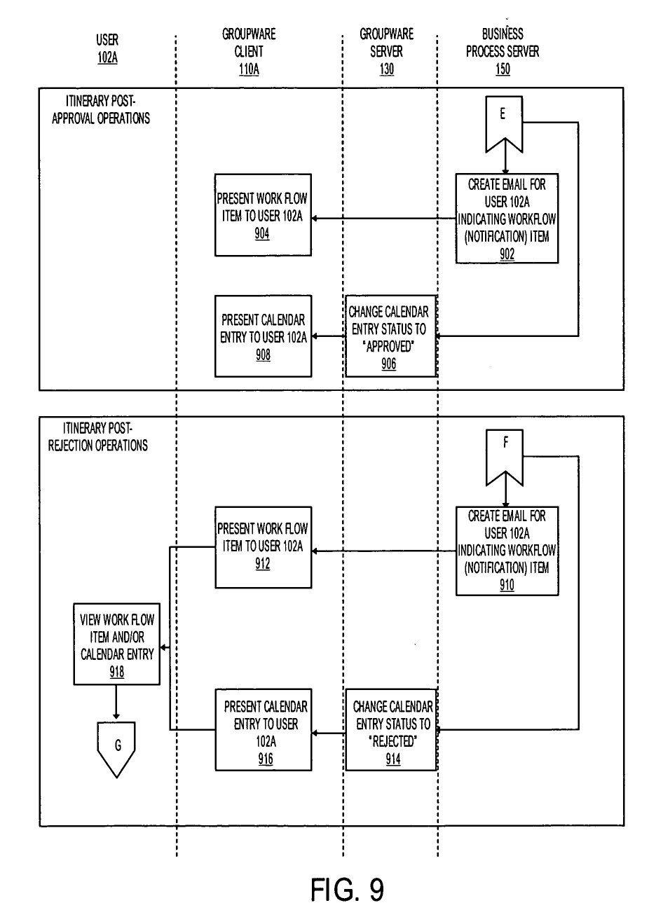

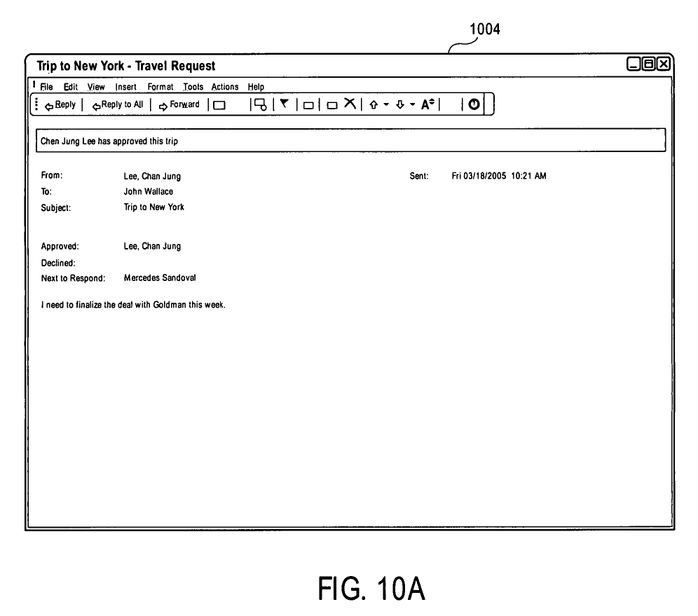

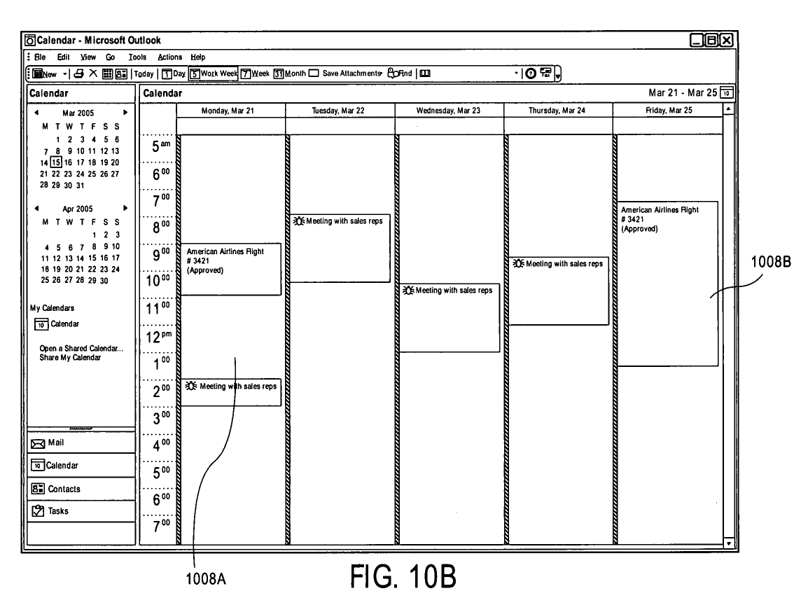

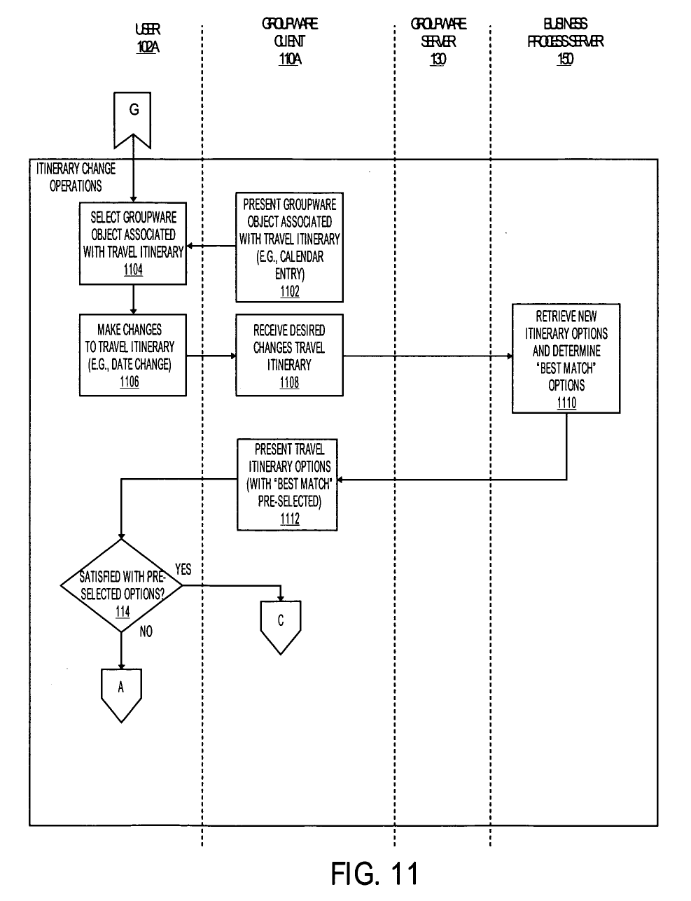

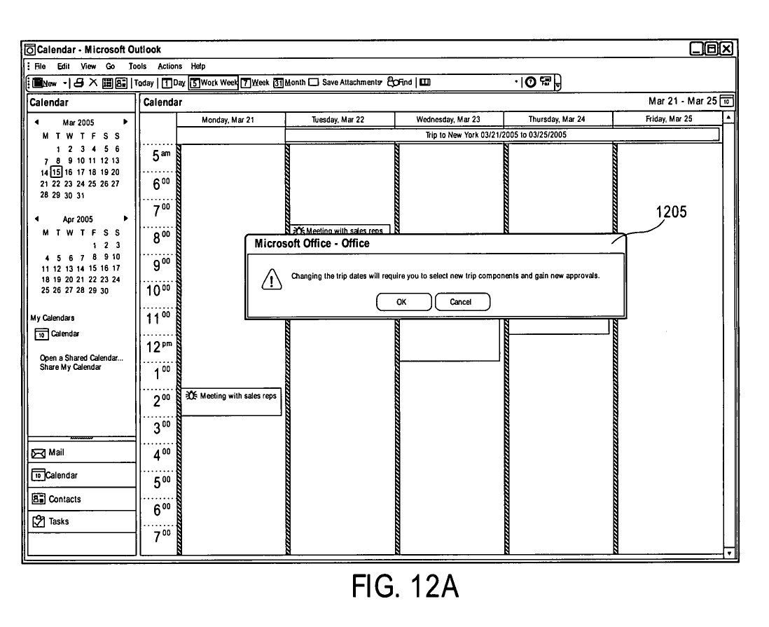

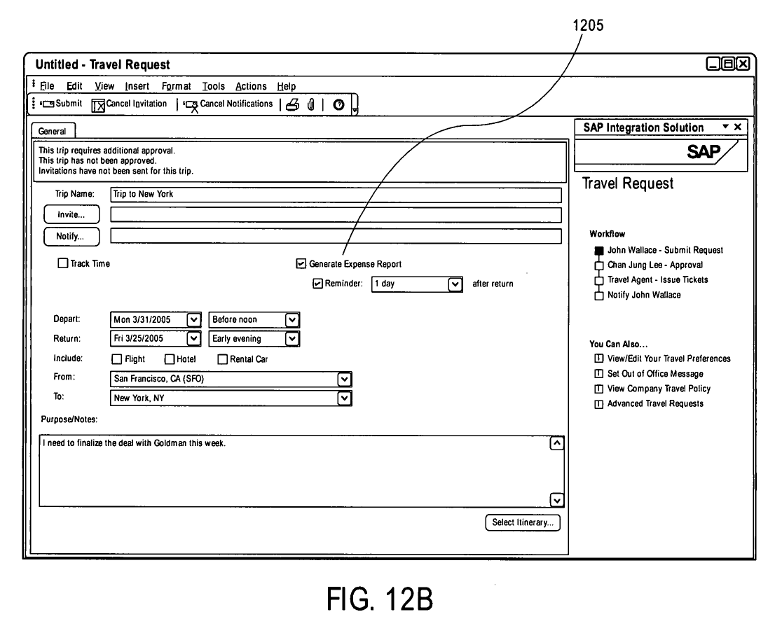

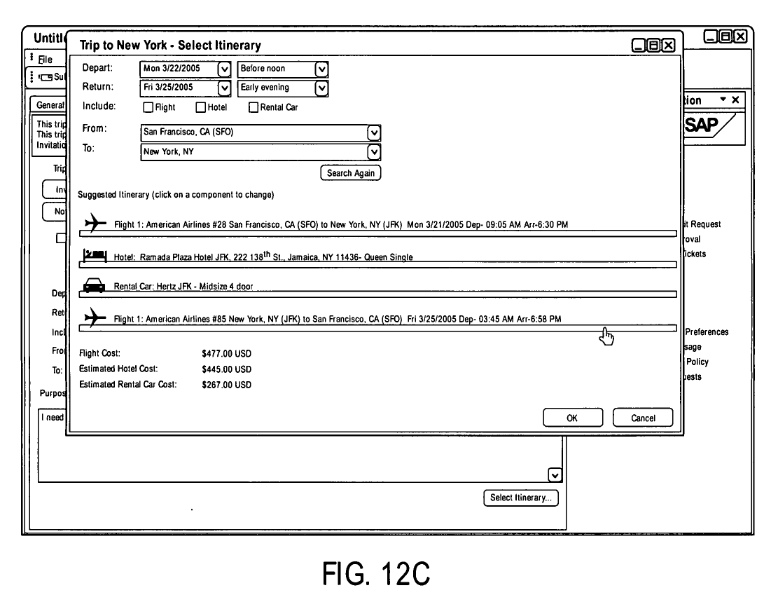

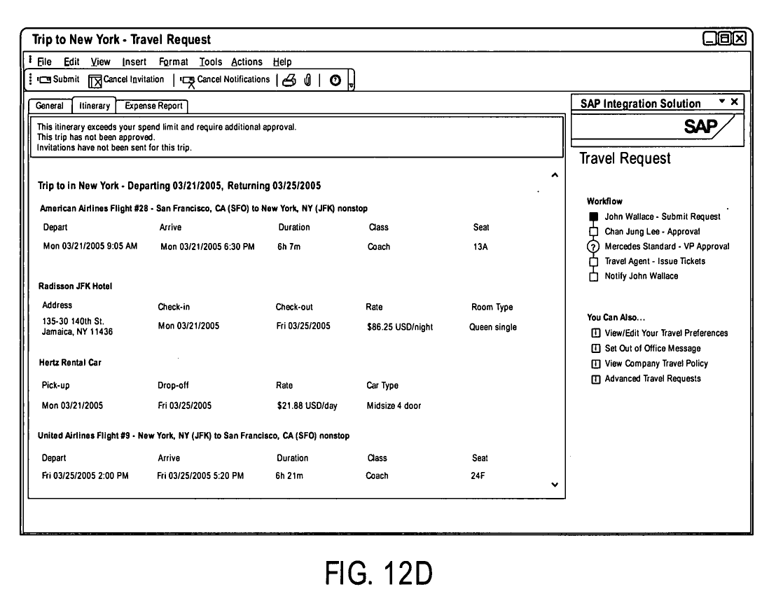

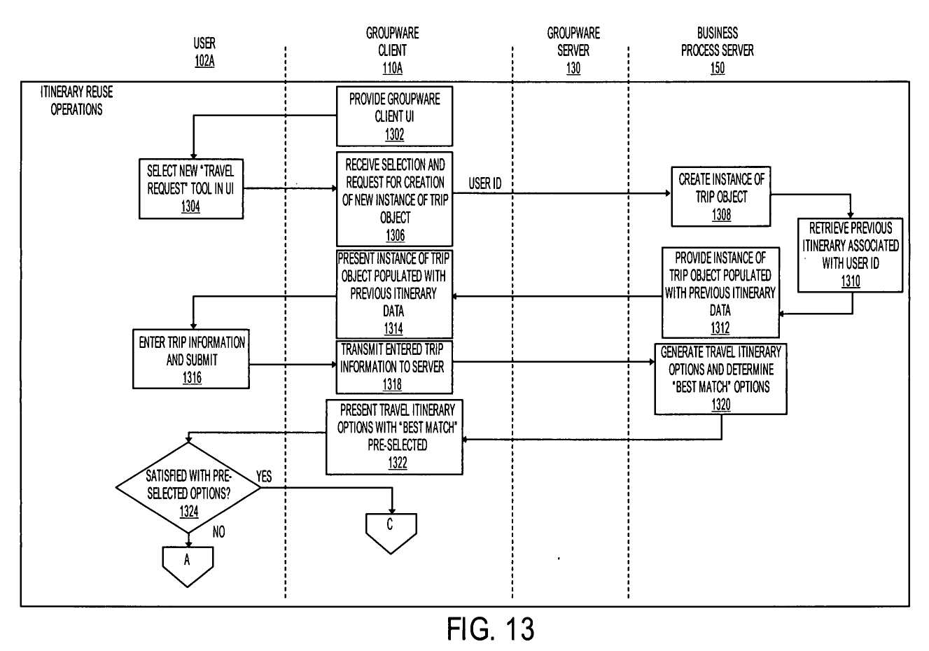

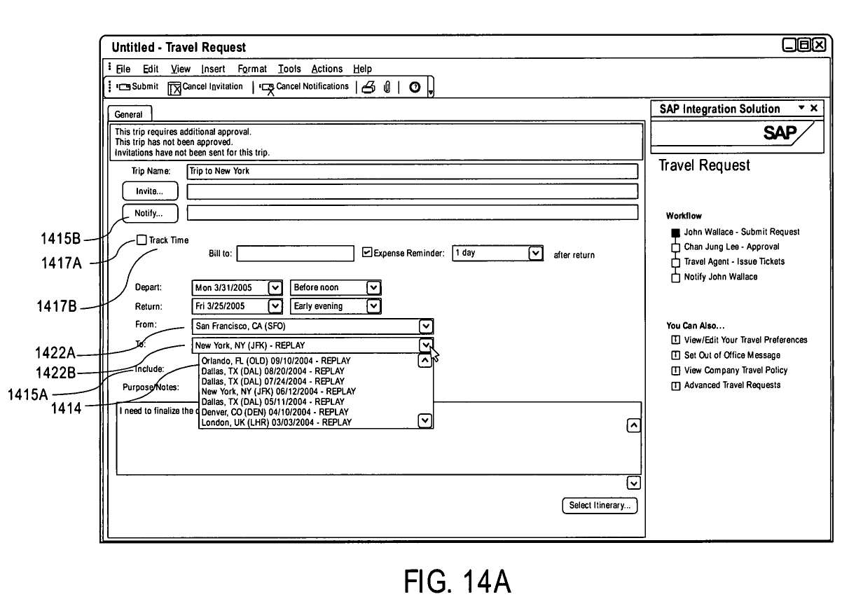

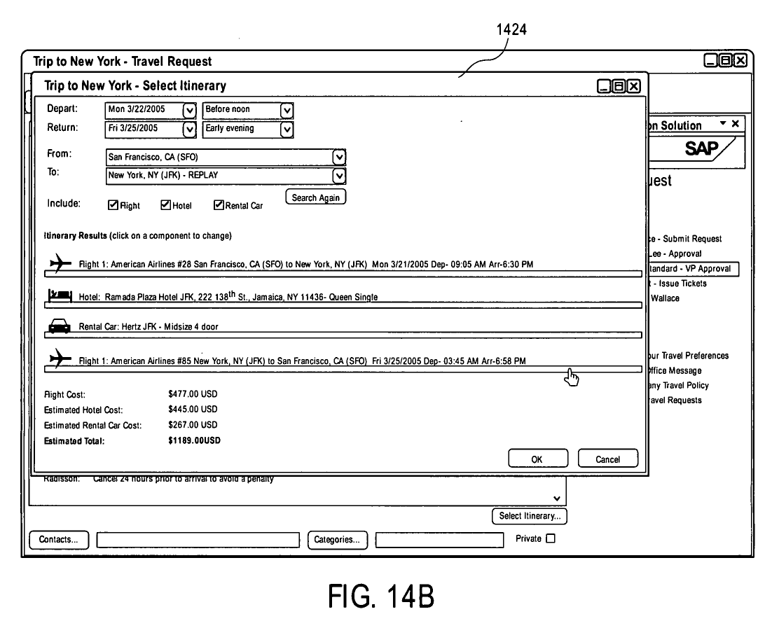

FIGS. 3a-14b provide additional details regarding the groupware travel itinerary creation shown in FIG. 2. FIGS. 3a-4g provide details regarding itinerary creation operations; FIGS. 5-6b provide details regarding itinerary approval operations; FIGS. 7-8b provide details regarding reporting operations; FIGS. 9-10b provide details regarding post-approval and post-denial operations; FIGS. 11-12d provide details regarding itinerary change operations; and FIGS. 13-14b provide details regarding reuse operations.

In FIG. 3, at 300, the groupware client (e.g. 110A) provides a groupware client user interface (UI). The UI may be a graphical user interface (GUI) such as the GUI 400 shown in FIG. 4a. The groupware client provides tools via the user interface enabling the groupware client user to collaborate with other groupware users and interact with backend applications (e.g. 154D).

At 312, a groupware client user (e.g. 102A) uses the tools in the groupware client user interface to create a workflow object. In this example, the user selects a “travel request” tool in the UI. For example, the user may select the “travel request tool” 412 shown FIG. 4a. In response to the selection, the groupware client 110A transmits a request to the business process server to create a new instance of a trip object (also referred to creating a new trip object or creating a new travel request object). At 316, the business process server creates an instance of a trip object and provides the instance at 318 to the groupware client, e.g. by using the groupware interface 152 to place the trip object in a format understandable by the groupware (i.e. the groupware server and/or clients).

At 320, the groupware client provides the instance of the trip object to the user. In one example, the groupware client presents the instance of the trip object in a GUI, e.g. the the GUI 420 shown in FIG. 4b.

Provided with the tools in the GUI 420, the user 102A enters trip information into field provided via the GUI and submits the information at 322. Considering FIG. 4B, for example, the user enters the trip name: “Trip to New York” into the Trip Name field 422A. The user also selects a departure date and time (422B), a return date and time (422C), an airport from which the user prefers to depart (422D), an airport to which the user prefers to arrive (422E), and types of travel components (e.g. flight, hotel, rental car, etc) the user would like to include (422F) in the itinerary.

Text field tool 422G enables the user to enter additional text to be associated with the trip, e.g. a purpose and/or notes. This text is viewable by other workflow participants, e.g. the user 102B when the user 102B receives the submitted itinerary or the user 102C who may be another workflow participant receiving notification of the trip. Tool 422H enables the user to select other workflow participants to notify of the trip, e.g. the user's supervisor, colleagues, and/or assistants.

To assist the user in entering appropriate information into the input fields provided by the GUI tools, the GUI 420 provides a task pane 410 which includes a tool 401 enabling the user to view and/or edit the user's personal travel preferences. The task pane 410 also includes a tool 405 enabling the user to view the company's travel policy (or a travel policy of an organization authorizing the trip). These tools assist the user in submitting information which will have a greater chance of approval.

Task pane 410 also includes a tool 403 enabling the user to set an out of office message. For example, in use, the user uses the tool 403 to configure the groupware (client and/or server) to transmit a reply email to any emails received during the travel dates. The reply email indicates that the user is out of the office and may include information on when the user will be returning based upon the travel itinerary. Because the travel itinerary is being creating using groupware, the user is provided with convenient tools which facilitate the trip, including enabling the traveling user to notify many individuals about the trip, including contacts who are not participants in the workflow associated with creating the travel itinerary.

Tool 424 enables the user to submit the trip information entered into the input fields (including selection menus).

At 324, the groupware client transmits the entered trip information to the business process server. Based on the information, the business process server at 326 (e.g. in the backend application 154D) generates travel itinerary options at 326. The business process server 326 also determines a “best match” among the options generated.

For example, the user may determine the departing flight which most closely adheres to the information the user entered at 322 (e.g. departure city, departure time, etc). In certain configurations, the business process server 326 determines the best match using the submitted travel information. In one implementation, the business process server 326 also uses the user's preferences (e.g. editable using tool 401), the organizational travel policy (e.g. viewable using the tool 405), and/or the user's past travel itineraries (described in further detail below). The business process server transmits the options, with the best matched options identified to the groupware client.

At 328, the groupware client presents the options with the best match options pre-selected. For example, in FIG. 4C, the groupware client presents a GUI 428. The GUI 428 includes tools which enable the user to change a selected option for an itinerary component. For example, the GUI 428 includes tools 429A, 429B, 429C, 429D, and 430.

Each of the tools 429A, 429B, 429C, and 429D is a clustered object selector. A clustered object selector is a tool (e.g. a selection menu) that allows for the selection of grouped items or data elements. A clustered object selector generally displays a current selection (i.e. a selected option) while hiding alternative options from view until a tool (e.g. 430) associated with the clustered object selector (e.g. 429A) is selected. The tool (e.g. 430) associated with the clustered object selector (e.g. 429A) may be a feature of the clustered object selector or a separate tool.

In FIG. 4C, each of the tools 429A, 429B, 429C, and 429D have been pre-selected with the “best match” options as identified by the business process server 326. For example, the tool 429A is pre-selected with a departing flight chosen based on the submitted travel information, and possibly also based on the user's preferences, the company policy, and/or a past travel itinerary of the user. The tool is configured such that the user can alter the selection using an arrow 430, for example, as described in more detail below with regard to a tool 442A shown in FIG. 4F. In FIG. 4C, the other tools 429B, 429C, and 429D are also presented with a pre-selected option.

Displayed together as a group, the tools 429A, 429B, 429C, and 429D are referred to as grouped selectors. A grouped selector may have dependencies (e.g. contextual dependencies) between the clustered object selectors in the group. For example, in one implementation, a selection in one clustered object selector affects the items (or options) available or the item (or option) selected in another clustered object selector. For example, in certain implementations, changing the selected option of the tool 429A (Flight 1) from JFK airport to another airport (e.g. LaGuardia Airport) changes the options available via the tool 429C (Rental Car) from Hertz JFK to another rental car company located at the other airport (e.g. Hertz LaGuardia).

At 330, a decision is made to determine whether the user is satisfied with the itinerary presented in the GUI 428 (e.g. with the pre-selected options). If the user is satisfied, the user selects a tool 432 (a submission button) indicating satisfaction with the itinerary.

In response, at 332, the groupware client submits the travel itinerary, approved by the traveling user 102A, to the backend. At 334, the groupware server creates an entry in a calendar associated with the user. At 336, the groupware client presents the calendar entry to the user.

FIG. 4D shows an example of a groupware client calendar having such an entry. The calendar seen in FIG. 4D is another GUI presentation of the groupware client. In FIG. 4D, the calendar entry 436 is shown with a “tentative” status, indicating that the travel itinerary has not been formally approved, e.g. by a workflow participant having a supervisory role.

At 338, the business process server makes reservations based on the travel itinerary approved by the traveling user 102A. In one implementation, a backend application 154 communicates with an airline company's server to place a 24-hour hold on appropriate tickets. The backend application 154 also communicates with a hotel reservation system to reserve an appropriate room.

At 340, the business process server also creates a workflow object representing a workflow item (e.g. a task) for another workflow participant, e.g. the user 102B. For example, in one configuration, the backend application 154 in the business process server includes a service creating a workflow item for another user (e.g. 102B). The workflow item is created in response to receiving from the user 102A a travel itinerary based on the options provided. The groupware interface 152 in the business process server is connected to the groupware server. Using the groupware interface 152, the service in the backend application notifies the user 102B of the workflow item via the groupware server. For example, the service may transmit a workflow object to the user 102B. The workflow object is presented as a GUI including tools enabling the user 102B to approve or reject the itinerary, as described in more detail below.

If the user is not satisfied with the pre-selected option at 330, then the flow diagram continues (via block A) to FIG. 3B.

In FIG. 3B, at 342, a different itinerary option is selected using the tools provided by the groupware client. For example, in FIG. 4E, by selecting an arrow 446A, the groupware client displays additional itinerary options available to the traveling user. In the example shown, five additional options are available for the hotel itinerary component. Details regarding each of the options, e.g. distance to the airport and amenities, are shown to assist the traveling user 102A in creating his/her itinerary.

The GUI shown in FIG. 4E also includes a tool 446B which enables the user to check the current availability of a travel itinerary option. For example, in FIG. 4E, the user 102A checks for availability of a room at the Ramada Plaza Hotel during the travel dates by selecting the tool 446B. In response, the groupware client communicates the request to check for availability of the room to the business process server. The business process server communicates with an external service, e.g. a hotel reservation service, to determine availability of a room at the associated hotel during the travel dates. The business process server communicates the result of the determination to the groupware client, which then presents the results to the user, e.g. via another GUI presentation.

FIG. 4F shows the GUI presentation of 4E when the options for the returning flight is presented (e.g. by selecting the tool 442A), instead of the hotel itinerary options for the hotel. When the tool 442A is selected (e.g. by the user), data elements of the clustered object selector 429D that are not selected (i.e. the alternative options) become visible. In FIG. 4F, six additional (alternative) options beyond the pre-selected “best match” option are shown. Details regarding each of the options, e.g. airline, airports, departure/arrival times, and duration are shown to assist the user in creating his/her itinerary.

In certain implementations, when the alternative options are visible, tools enable the user to interact with the options, e.g. to sort, filter, and otherwise manipulate the display of the data elements. For example, in one configuration, the text 442C (“Duration”) is associated with a sorting tool. While the alternative options are visible, the text 442C is also accessible to the user. Selecting the text 442C rearranges the data elements clustered by the clustered object selector 429D to list the data elements in order based on flight duration rather than in order based on cost.

While the alternative options are visible, the user selects an option by selecting a tool provided in association with the option, e.g. a tool 442B. In one configuration, in response to the user selecting an alternative option (e.g. using the tool 442B), the clustered object selector 429D hides the alternatives from view, displaying the newly selected option in place of the previously selected option (e.g. the previously selected “best-match” option).

After the user selects one or more itinerary options, the user may select a tool (e.g. a tool 443) indicating to the groupware client that the user is done selecting. In response to the user selecting an itinerary option, the groupware client updates the itinerary at 344.

Updated itinerary information is communicated to the business process server. At 346, the server determines availability of the selected option(s). In certain configurations, the business process server uses the same instructions to determine the availability of a selected option as used when the tool 446B is selected (e.g. to check availability of a hotel). In FIG. 3B, the business process server determines the availability of updated itinerary information in response to the user selecting the tool 443. For example, if the user selects the tool 442B in FIG. 4F to select the United Airlines Flight, and then selects the tool 443, the flight selection information is transmitted to the business process server. At 346, the business process server, using a backend application, determines whether the selected flight is available for booking.

Typically, the selected option is available since the business process server recently retrieved the option from the external service (e.g. flight reservation service), e.g. at 326. However, in certain circumstances, a certain option may become unavailable while the user 102A was creating his/her itinerary (e.g. another traveler has reserved the last available room or seat). In those circumstances in which the selected option is not available, the business process server returns an error to the groupware client which then enables the user 102A to select a different itinerary option.

If the business process server determines that the selected option is available at 346 (e.g. if a seat on the United Airline flight is available), the business process server determines if any sub-options related to the selected option exists at 348. For example, when the selected option is a flight option, the business process server typically determines if the option allows the user to select a seat on the flight. Sub-options may not be available for certain selected options. For example, certain airlines do not allow a user to select a seat during the booking process. Other airlines will determine a default seat for the user during booking, but will permits the user to change the assigned seat.

When sub-options for the selected itinerary option are available, at 350, the business process server returns the sub-options to the groupware client. At 352, the groupware client presents the sub-options to the user. For example, in certain configurations, the groupware client presents a GUI presenting the various sub-options available to the user, e.g. seats on a plane. At 354, the traveling user (e.g. 102A) selects from the sub-options. The operations then repeat wherein the updated itinerary information is again communicated to the backend process server.

If sub-options are not available (or not applicable), the business process server returns the availability of the selected itinerary option to the groupware client at 356. At 358, the client presents the availability of the option to user, e.g. by updating an itinerary summary.

FIG. 4G shows an itinerary summary updated after the user selects one or more itinerary options which are confirmed as available by the business process server. In FIG. 4G, the flight option selected by the user, United Airlines Flight #9, is shown instead of the previously pre-selected “best match” option, American Airlines #85, shown in FIG. 4C. The text field 458 indicates that a seat was selected (e.g. by the user at 354 or automatically by the external reservation system).

At 360, the user decides if the user is satisfied with the options. If the user is not satisfied, the groupware client provides a tool 460 enabling the user to modify the itinerary. The operations then repeat until the user is satisfied with the travel itinerary.

When the user 102A is satisfied with the travel itinerary, the flow diagram returns to FIG. 3A via block C to submit the travel itinerary now approved by the user 102A to the backend.

As can be seen in FIG. 4G, the groupware client is not merely an interface presenting consolidated travel reservation options to a user. The groupware client, along with the groupware server and business process server, integrates travel reservations with other backend applications used by the enterprise.

For example, the FIG. 4G, the groupware client notifies the user using text field tool 461 that the selected itinerary exceeds the user's spending limit, which may be set by the enterprise's travel policy or the travel policy of another organization that the paying for the trip, for example. The notification also indicates to the user that the itinerary will need additional approval because it exceeds the spending limit. The tool region 462 automatically indicates that the workflow for the process of creating a groupware travel itinerary has an additional task that must be completed, e.g. approval by the vice president shown as an additional text field at 463. A question mark is associated with the text field since a change in the itinerary may alter the need for approval by the vice president.

Accordingly, the invention facilitates convenient and consistent adherence to an enterprise's travel policies and procedures, thereby reducing the time required to correct internal procedural errors in creating a travel itinerary. The workflow shown in FIG. 4G also enables the user, as well as other groupware users viewing the travel request, to see which stage the workflow is current in. In this case, the workflow is at the request submission phase since the traveling user is creating the desire itinerary for submission to other groupware users (e.g. a supervisor 102B and, now, the vice president) for approval.

The GUI shown in FIG. 4H provides the user with additional details regarding the itinerary option. In FIG. 4H, the GUI indicates the cost of each of the selected options in region 438. The GUI also indicates that, with the selected options, the user is $80.00 over the user's allotted spending limit. Accordingly, the user may modify the itinerary to reduce the overall cost, thereby ensuring that vice presidential approval for the trip will be unnecessary under the company travel policies.

Returning to FIG. 3A, at 340, a workflow object representing a workflow item (e.g. a task) is created for another groupware user, e.g. the user 102B, in response to the creation of a travel itinerary that is satisfactory to the user 102A. In FIG. 3B, the flow diagram continues to FIG. 5 via block B.

FIG. 5 describes operations which occur during an itinerary approval process. In FIG. 5, in response to the creation of the workflow object, the business process server notifies the groupware client 110B of the newly created workflow object. For example, at 502, the business process server creates an email for the user 102B. The email indicates the workflow item represented by the newly created workflow object. In this case, the email indicates a travel itinerary needing approval from the user 102B.

In one configuration, at 504, the business process server also retrieves relevant budget information. For example, a backend application in the business process server may retrieve an allotted budget value for the current quarter or for the present business workflow. Accordingly, the groupware client 110B receives from the backend budget information along with the travel itinerary.

At 506 and 508, both the email created at 502 and the budget information retrieved at 504 is provided to the user 102B, via the groupware client 110B. The groupware client 110B enables the user 102B to view the workflow item (e.g. the task of responding to the travel request submitted by the user 102A) and the budget information at 510.

FIG. 6A shows a GUI 610 provided by the groupware client 110B that enables the user 102B to view the workflow item and the budget information. In FIG. 6A, the budget information is provided in association with the email, e.g. in a region 608 of the GUI 610. Region 608 presents an allotted travel budget for the current workflow, an amount of the budget that has been actually been used to date, and a projected amount remaining in the budget. The region 608 also shows which stage the workflow is current in. In this case, the workflow has completed the submission request stage and is in an approval stage. The region indicates that, after the approval stage, three stages remain in the current workflow before the workflow is complete.

Region 608 also provides a tool enabling the user 102B to view the company travel policy. This enables the user 102B to determine whether the company travel policy is being complied with. Accordingly, embodiments of the present invention facilitate adherence to policies implemented by an enterprise at every stage of a workflow. The groupware integrated with the business process server together provide policy reminders and enforcement.

In FIG. 6A, the email notifying the user 102B of the workflow task is not a simple text email. Rather, the email is a workflow object which the groupware server transmits to an inbox of the user 102B's groupware client. The email includes GUI tools not available in a traditional email (e.g. a simple text email). For example, in FIG. 6A, the email includes a reply tool 612, a delegate tool 630, an approval tool 616A, and a rejection tool 616B. Each tool allows the user 102B to provide a response to the travel request submitted by the user 102A to the system. Accordingly, the term “email” used herein includes any workflow object which is placed in an email inbox of a groupware client.

The reply tool 612 enables the user 102B to reply to the submitted travel request without either approving or rejected the request. In one configuration, selecting the reply tool 612 initiates a creation of a reply email directed to the traveling user 102A. The supervising user 102B then composes the email text and sends the email to the user 102A, e.g. to ask questions regarding the trip. Accordingly, the reply tool 612 enables initiation of a collaboration session with the user 102A. In other configurations, a different type of collaboration session is initiated, e.g. an instant messenger session or a voice over IP (VoIP) session. A collaboration session enables the user 102B to discuss the travel itinerary with the user 102A, either delayed in time (e.g. via email) or in real-time (e.g. via instant messenger).

To facilitate understanding and discussion of the travel itinerary, the GUI 610 also includes a readily accessible tool 632, which, when selected, displays the itinerary created and submitted by the user 102A. FIG. 6B shows the GUI 610 when the tool 632 is selected, with the itinerary created and submitted by the user 102A visible to the user 102B. Accordingly, the tool 632 facilitates creation of a groupware travel itinerary in which multiple individuals may view, approve and/or edit items of the travel itinerary.

The delegate tool 630 enables the user 102B to add additional users to the workflow at 514. For example, in one implementation, the user 102B is responsible for approving travel requests by default, but under the enterprise's organization structure, the user 102B is permitted to assign approval of certain travel requests to certain other individuals.

The approval tool 616A and rejection tool 616B enables the user 102B to approve or deny, at 516, the submitted itinerary created by the user 102A. If the user 102B accepts the itinerary, the user 102B selects the approval tool 616A. At 518, the groupware client 110B communicates the approval to the backend.

At 520, the itinerary, now approved by both the traveling user 102A and the supervising user 102B, is communicated to a backend application, e.g. a backend application tracking and processing travel expenses. At 522, the business process server confirms the reservations, e.g. using the backend application tracking and processing travel expenses and/or another backend application in the business process server. As discussed above, in typical configurations, during the creation and submission of the itinerary by the traveling user 102A, a temporary reservation is made. The temporary reservations are confirmed in response to approval by a workflow participant responsible for approval to submitted travel request, e.g. 102B.

In response to approval of the itinerary of the travel request, the backend also creates at 524 a workflow object (e.g. a notification object) for the traveling user 102A indicating approval of the travel itinerary. The notification object may be for, example, an email automatically generated by the business process server in response to receiving the approval. The notification may also be, for example, an alert automatically generated by the groupware server and transmitted to the groupware client 110A.

If the user 102B rejects the itinerary, the user 102B selects the rejection tool 616B. At 526, the groupware client 110B communicates the rejection to the backend. At 528, the backend creates a workflow object (e.g. a notification object) for the traveling user 102A indicating rejection of the travel itinerary, similar to the object the business process server would have created at 524 to indicate the approval discussed above.

In certain implementations, after approval of the itinerary by the user 102B, the operations continue from FIG. 5 to FIG. 7 via block D.

FIG. 7 describes operations associated with reporting expenses associated with the travel. At 702, the business process server, e.g. in a backend application, generates an expense report. In one implementation, the report is generated based on selection of a tool (e.g. 1205 in FIG. 12B) which determines whether a report will be generated and when the report will be generated. In one implementation, the report is a separate file, which is attached to groupware workflow objects (e.g. an email object) for transmission to another groupware client. At 704, the business process server creates a workflow object to communicate the expense report to a workflow participant. For example, the workflow object may be an email object having the workflow item (e.g. the report) attached to the workflow object.

In FIG. 8, the email associated with the report is transmitted to three workflow participants. The report is transmitted to the (traveling) user 102A who created the initial itinerary and submitted the itinerary in a travel request for approval (operations of FIGS. 3A-3B). The report is also transmitted to the (supervising) user 102B who reviewed the travel itinerary and approved of the submitted travel request, with or without modifying the itinerary (operations of FIG. 5). The report is further transmitted to another user 102C, who may be, for example, the vice president who is now part of the workflow because the cost of the trip exceeds a budgeted value.

At 706, 708, and 710, the email is presented to the respective user via the respective groupware client 110A, 110B, and 110C. At 712, 714, and 716, the respective groupware users view the respective emails. In certain implementations, the email may be identical, e.g. when the each user is listed as a recipient of the same email. In other implementations, the email is customized for each recipient based on the status of the user and/or of the workflow. For example, in one implementation, the user 102A receives an email indicating the request has been approved by the user 102B and an expense report has been generated and transmitted to another user, e.g. 102C. The user 102C receives an email, with the expense report attached, indicating that the user 102C is responsible for taking the next action in the workflow.

FIG. 8A shows a GUI representation of one workflow object (e.g. the email) having an expense report associated with the object (e.g. attached to the email). In FIG. 8, the GUI representation 810 is a modified version of the representation viewed by the user 102B at 510.

The GUI representation 810 includes a region 808 showing which stage the workflow is current in. In this case, the workflow has completed the submission request stage and is still in an approval stage (e.g. an approval stage in which additional approval is being obtained, e.g. by the vice president). As discussed above, this additional workflow task was automatically added to the workflow based on the results of the itinerary created by the user 102A. In one implementation, if the user 102B, after discussion with the user 102A, modified the itinerary such that the travel expense is below a budgeted amount, then the business process server automatically removes this task from the workflow.

The GUI representation 810 also includes a tool 805, which, when selected, enables the user viewing the GUI representation to view the expense report generated by the business process server at 702. In FIG. 8A, the expense report is a file is attached to the object. FIG. 8B shows one representation of the expense report which is provided when the file is opened. In certain implementations, selection of the tool 805 automatically shows this expense report in the region 811. As seen in FIG. 8B, the report includes a region 817 indicating that the report is to be signed. Accordingly, in one implementation, the groupware client enables workflow participants to print a report for submission as a hardcopy in order to facilitate compliance with a company policy.

Returning to FIG. 5, as discussed above, the business process server creates at 524 or 528 a workflow object (e.g. a notification object) for the traveling user 102A indicating approval or rejection, respectively, of the travel itinerary. The workflow object may be for, example, an email automatically generated by the business process server.

FIG. 9 shows a flow diagram of post-approval and post-rejection operations. At 902, the workflow object indicating the workflow item (e.g. the notification of an approval) is created. As described above, the workflow item may be an email. At 904, the groupware client 110A presents the workflow item to the user 102A. FIG. 10A shows one GUI 1004 representing the workflow object. In FIG. 10A, the GUI indicates to the user 102A that the user 102B has approved of the trip, and accordingly of the itinerary.

In one implementation, at 906, the groupware server also changes the calendar entry which was created at 334. The groupware server changes the calendar entry to indicate that the status of the trip is “approved” rather than “tentative.” At 908, the groupware client presents this calendar entry to the user 102A, e.g. after the groupware client 110A synchronizes with the groupware server. FIG. 10B shows the GUI shown in FIG. 4D, now updated with the new calendar entry status. As seen in FIG. 10B, the calendar entries 1008A and 1008B indicating the flight times for the trip has a status of “approved.” In one implementation, the groupware client initiates the change in the calendar entry status.

When the travel request (and itinerary created and submitted by the user 102A) is rejected by the user 102B, at 910, the workflow object indicating the workflow item (e.g. the notification of a rejection) is created. At 912, the groupware client 110A presents the workflow item to the user 102A. At 914, the groupware server changes the calendar entry, which was created at 334, to indicate that the status of the trip is “rejected” rather than “tentative.” This change provides additional notification to the user 102A, and any other groupware users having access to the groupware calendar of the user 102A, such as an assistant, of the rejection of the travel itinerary. At 916, the groupware client presents this calendar entry to the user 102A, e.g. after the groupware client 110A synchronizes with the groupware server. At 918, the user 102A views the workflow item and/or the calendar entry. The operations then continue to FIG. 11 via block G.

FIG. 11 describes operations relating to changes to a submitted itinerary (e.g. in response to a rejection by the user 102B). At 1102, the groupware client 110A presents a groupware object associated with the travel itinerary to the user 102A, e.g. an email, a calendar entry, or a task list object.

At 1104, the user 102A selects a groupware object associated with the travel itinerary. For example, in one implementation, the groupware client 110A presents an email to the user 102A indicating the rejection. The email includes a link to a groupware object associated with the travel itinerary, e.g. the calendar entry. The user 102A selects the link to select the groupware object associated with the travel itinerary.

In another implementation, the groupware client presents the groupware object associated with the travel itinerary, e.g. a calendar entry, to the user 102A by presenting a calendar GUI. The user 102A selects the groupware object associated with the travel itinerary by selecting a specific calendar entry. Accordingly, the groupware receives a selection of the calendar entry. In response to the selection, the groupware enables alteration of the travel itinerary.

At 1106, the user 102A makes changes to the itinerary, e.g. changing a date of the itinerary. In one example, the user 102A clicks and drags the calendar entry to a different date.

The groupware client receives the desired changes at 1108 (e.g. by detecting the moved calendar entry). In one implementation, the groupware client notifies the user that the desired change requires additional operations. For example, in FIG. 12A, the groupware client alerts the user 102A (via an alert box 1205) that changing the trip dates will require selection of new trip components, e.g. a new flight. The alert also indicates that new approvals will be needed. The user 102A may attempt to change the itinerary after a rejection or an approval of the itinerary by another groupware user, or while approval or rejection is still pending.

FIG. 12B shows a GUI representing a workflow object that is presented to the user 102A in response to receiving an indication that the user desires to change an itinerary. Using the GUI shown in FIG. 12B, the groupware client enables the user to alter the itinerary.

At 1110, the business process server retrieves new (updated) itinerary options and determines a “best match” options for each itinerary component. At 1112, the itinerary options, along with the “best match” options identified, are presented to the user 102A similar to the operations described above with regard to FIGS. 3A-3B.

FIG. 12C shows a GUI presented to the user 102A in accordance with operation 1112. If the user 102A is satisfied with the pre-selected options, the operations return to FIG. 3A via block C. If the user 102A is not satisfied with the pre-selected options, the operations return to FIG. 3B via block A. FIG. 12D shows a GUI representing a workflow object showing the travel itinerary after the changes of FIG. 11.

FIG. 13 shows operations associated with creating a groupware travel itinerary based on past itineraries. At 1302, the groupware client 110A provides a groupware UI similar to the UI described above with regard to operation 300. At 1304, the groupware client user 102A uses the tools in the groupware client user interface to create a workflow object, similar to the operation 312 described above. At 1306, the groupware client 110A receives the selection and transmits a request to the business process server to great a new instance of a trip object. The request transmitted to the business process server includes an identifier of the user 102A, e.g. an employee identifier.

At 1308, the business process server creates an instance of a trip object. At 1310, the business process server determines whether the user identifier is associated with any past travel itineraries, e.g. in circumstances in which the user 102A is a repeat traveler. If the user identifier is associated with a past itinerary, the business process server retrieves the data associated with the past itinerary (e.g. stored in the enterprise data database 160).

At 1312, the business process server provides the instance of the trip object populated with the past itinerary data. For example, rather than providing a workflow trip object with a blank “From:” airport field 1422A and a blank “To:” airport field 1422B, the business process server provides the workflow trip object with the From and To field populated with the last trip itinerary From and To field values. In other implementations, the business process server populates the trip object instance with the most frequent travel itinerary values among a plurality of past trip itineraries, rather than values from the most recent travel itinerary. In certain implementations, the business process server also uses other factors to determine what values to populate the instance of the trip object with. For example, the business process server may determine what values to populate the trip object instance with based on at least one of: the user's organization role, a company travel policy, and travel preferences defined by the user.

In FIG. 14A, the trip object instance provides a selectable list 1414 of destination locations, the locations determined by the business process server based on one ore more past travel itineraries. When one of the options in the list is selected, the groupware client populates the remainder of the information related to the current trip with information based on the past itinerary associated with the selected option. For example, if the London option is selected, the “Include” tool 1415A is automatically populated with the past “Include” selections from the prior London trip (e.g. hotel but not rental car), and the “Notify” tool 1415B is automatically populated with the names of workflow participants who were notified of the prior London trip. This configuration reduces time a repeat traveler spends on creating and submitting a travel itinerary.

At 1316, the user 102A enters any additional trip information, e.g. a purpose of the trip, additional text describing the name of the trip, and whether to track time (1417A) associated with the trip and to whom to bill the tracked time (1417B).

At 1318, the trip information is transmitted to the backend, similar to the operation 324 described above. At 1320, the business process server generates travel itinerary options based on travel information and determines the “best match” option for each itinerary component, similar to the operation 326. In one implementation, the business process server determines the “best match” option based at least in part on the past travel itinerary selected from the list 1414.

At 1322, the groupware client presents the travel itinerary with the best match options pre-selected, e.g. in a GUI 1424 shown FIG. 14B. If the user 102A is satisfied with the pre-selected options at 1324, the operations return to FIG. 3A via block C. If the user 102A is not satisfied with the pre-selected options, the operations return to FIG. 3B via block A.

In certain embodiments, operations described herein are performed when a machine readable medium having instructions are executed by a processor. A machine readable medium includes any mechanism that stores and/or transmits information/content/instructions in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for facilitating groupware creation of a travel itinerary comprising:
receiving, via a groupware client, a request to create a first travel itinerary for a trip of a user having a user identifier;
in response to the request, querying a database for a second travel itinerary stored in association with the identifier;
providing, via the groupware client, the second travel itinerary as elements of an interface of the groupware client;
receiving, via the interface of the groupware client, information relating to the trip;
generating travel itinerary options based on the information;
identifying from among the travel itinerary options a best match based on a travel policy of an organization authorizing the trip; and
transmitting to the groupware client the travel itinerary options with the best match pre-selected.

2. The method of claim 1, wherein receiving the information comprises receiving the information from a groupware server.

3. The method of claim 1, further comprising:
receiving from the groupware client a selection from among the travel itinerary options;
generating a workflow item for an individual authorized by the organization to review the selection; and
notifying the individual of the workflow item via a second groupware client used by the individual.

4. The method of claim 3, wherein the second groupware client includes an email client and notifying the individual comprises transmitting an object to the email client, the object including one or more tools selectable by the individual to approve or deny the selection.

5. The method of claim 3, further comprising:
determining the individual authorized by the organization to review the selection based on at least one of: an organizational role of the user, a purpose of the trip, and a cost associated with the selection.

6. The method of claim 3, further comprising:
automatically generating another workflow item for another individual in the organization when the selection is associated with a cost exceeding a budgeted value.

7. A machine readable medium having instructions which when executed by a processor cause the processor to perform operations comprising:
providing, in a groupware client, a tool to create a travel itinerary;
in response to selection of the tool, providing an interface in the groupware client to receive trip information;
transmitting the trip information to a backend application;
receiving from the backend application travel itinerary options, at least one of the options identified as a best match option;
presenting the options with the best match option pre-selected;
receiving a selection from among the itinerary options;
making a reservation based on the selection; and
automatically creating in the groupware client a calendar entry based on the selection.

8. The medium of claim 7, wherein the operations further comprise:
in response to the selection, creating a workflow item; and
transmitting a notification of the workflow item to a second groupware client.

9. The medium of claim 8, wherein the notification includes graphical user interface tools enabling approval or rejection of the selection.

10. The medium of claim 9, wherein the operations further comprise, in response to an approval of the selection, changing the calendar entry to indicate the approval.

11. The medium of claim 9, wherein the operations further comprise, in response to an approval of the selection, automatically generating an expense report based on the selection.

12. The medium of claim 7, wherein the operations further comprise:
receiving a selection of the calendar entry; and
in response to the selection, enabling alteration of the travel itinerary.

13. The medium of claim 12, wherein the operations further comprise:
in response to a request to alter the travel itinerary, retrieving from the backend application updated travel itinerary options.

14. A device for facilitating groupware creation of a travel itinerary comprising:
a storage system interface connected to a storage system storing a travel policy of an organization and a past travel itinerary of a user representing the organization;
a groupware interface connected to a groupware client, the groupware interface receiving trip information from the user via the groupware client; and
a backend application connected to the groupware interface and the storage system interface, the backend application providing travel itinerary options based on the past travel itinerary and the trip information, the backend application further identifying a best match from among the travel itinerary options based on the travel policy of the organization.

15. The device of claim 14, wherein the groupware interface is further connected to a groupware server and the backend application includes a service creating, in response to receiving from the user a travel itinerary based on the options provided, a workflow item for another user, the service further notifying the other user of the workflow item via the groupware server.

16. The device of claim 14, wherein the backend application includes a service which generates an expense report in response to receiving from the user a travel itinerary.

17. The device of claim 14, wherein the travel policy of the organization identifies at least one of: a travel budget maximum, a travel authorizing individual in the organization, a preferred airline, a preferred hotel chain, and a preferred vehicle rental company.

18. A system for collaborative determination of a travel itinerary comprising:
a business process server including a groupware interface and a backend application;
a first groupware client connected to the server via the groupware interface, the first groupware client receiving from the backend application travel itinerary options based on an organizational travel policy, the first groupware client further enabling a first user to select from the travel itinerary options to create a travel itinerary; and
a second groupware client connected to the groupware interface of the server, the second groupware client receiving from the server the travel itinerary and enabling a second user to approve or reject the travel itinerary.

19. The system of claim 18, wherein the second groupware client further receives from the server budget information along with the travel itinerary.

20. The system of claim 18, further comprising:
a groupware server connected to the business process server, the first client, and the second client, the groupware server creating in the first client a calendar entry having a tentative status in response to creation of the travel itinerary and changing the tentative status to an approved status in response to receiving from the second client an indication of approval of the itinerary by the second user.
